(19) United States
(12) Patent Application Publication
(10) Pub. No.: US 2018/0018613 A1
(43) Pub. Date: Jan. 18, 2018

(54) PROVIDING SOFTWARE FOR CUSTOMIZING ON-SITE SERVICES

(71) Applicant: eNex Solutions LLC, Provo, UT (US)

(72) Inventors: Andrew Richardson, Provo, UT (US); Blaine Richardson, Provo, UT (US)

(21) Appl. No.: 15/209,548

(22) Filed: Jul. 13, 2016

(51) Int. Cl. G06Q 10/06; H04L 29/08; H04W 4/02

(52) U.S. Cl. CPC G06Q 10/063116; H04W 4/02; G06Q 10/063114; H04L 67/18; H04L 67/306

(57) ABSTRACT

A service system provides customized services for customers. One or more embodiments generate an instance record associated with a first service of a service type based on a customer service profile. One or more embodiments send the first instance record to a client device associated with a service technician. At the client device, one or more embodiments allow a service technician to add a new service step to a hierarchy of service steps in the instance record. One or more embodiments receive instance information, including the new service step, from the client device in connection with the first service. Additionally, one or more embodiments store the instance information with the customer service profile.

### BACKGROUND AND RELEVANT ART

Providing in-home or on-site services to customers at residential or commercial locations of the customers typically includes employing and managing a large number of service professionals to travel to many different locations to perform the services. Each service can involve a number of different steps at each service location that varies by industry, service type, the individual needs of the customer, and the circumstances surrounding the service instance. Additionally, service providers often must meet certain regulatory standards based on federal, state, and local laws when providing the services. Because of the many variations and requirements that in-home or on-site services can involve, providing such services can involve a significant amount of setup and continuous management.

Many conventional service systems use printed forms or software programs to assist service professionals to perform the services for customers. Paper forms introduce some flexibility in the provision of on-site services due to the physical nature of the forms. However, the flexibility of paper comes at the cost of uniformity and reporting consistency across a company. Specifically, the use of paper forms may result in unreported or misreported service information due to paper forms being lost or filled out incorrectly. Thus, the use of paper forms can result in difficulty tracking the flow of and storage of paper forms, as well as the tracking of accurate service information.

Additionally, although conventional service systems that use software programs allow the service professionals to record information associated with the services in a digital format that provides electronic transmission and storage, the conventional systems also suffer many of the drawbacks associated with using paper copies. For example, conventional service systems use software that provides on-site service while requiring the service professionals to follow rigid, predetermined service steps that are presented in a static electronic file, which limits the customizability of the service and inhibits efficient reporting.

Furthermore, service providers are often limited in how they are able to receive payment for services. For instance, some conventional service systems limit payment to cash or check payment at the point of sale or point of service. Other service providers use separate electronic devices and/or software for performing/reporting the services and receiving payment. Thus, payment for services can sometimes be inconvenient for either or both the customer (e.g., due to the limited forms of payment) and the service providers (e.g., due to the use of separate software applications for provision of services and payment).

These and other disadvantages may exist with respect to conventional in-home or on-site service systems.

### SUMMARY

Introduced here are techniques/technology for providing software for customizing on-site services. One or more embodiments include systems and methods to provide customized on-site service to customers. Specifically, the systems and methods provide software that uses origin level templates and service type templates to generate instance records for customers to aid service technicians in completing services for the customers. For example, the systems and methods generate, at one or more servers, an instance record for a customer based on a service type in a customer service profile for the customer. The systems and methods send the instance record to a client device associated with a service technician for the technician to use in performing the service for the customer.

The systems and methods allow the service technician to view, customize, and perform service steps when providing a service to the customer. For example, the systems and methods display an instance record including a hierarchy of service steps on a client device associated with the service technician. The systems and methods allow the service technician to add new service steps to the hierarchy of service steps using the client device in connection with a service for the customer. Based on the input of the service technician to add service steps, the client device of the service technician sends instance information associated with the service to the servers for storing within the customer service profile.

Additional features and advantages of one or more embodiments of the present disclosure will be set forth in the description which follows, and in part will be obvious from the description, or may be learned by the practice of such example embodiments.

### BRIEF DESCRIPTION OF THE DRAWINGS

Various embodiments will be described and explained with additional specificity and detail through the use of the accompanying drawings in which:

FIG. 1 illustrates a schematic diagram of a service system in accordance with one or more embodiments;

FIGS. 2A-2B illustrate example graphical user interfaces for generating service templates in accordance with one or more embodiments;

FIGS. 3A-3L illustrate example graphical user interfaces for performing an on-site service in accordance with one or more embodiments;

FIG. 4 illustrates a schematic diagram of a service system in accordance with one or more embodiments;

FIG. 5 illustrates a flowchart of a series of acts in a method of generating an instance record associated with a service for a customer in accordance with one or more embodiments;

FIG. 6 illustrates a flowchart of a series of acts in a method of modifying an instance record in accordance with one or more embodiments; and

FIG. 7 illustrates a block diagram of an exemplary computing device in accordance with one or more embodiments.

### DETAILED DESCRIPTION

One or more embodiments of the present disclosure include a service system for providing customized on-site services for customers. Specifically, the service system generates digital instance records that guide service technicians in performing services step-by-step for customers. For example, the service system generates instance records for customers using an origin template for a specific service type. The origin template includes a hierarchy of service steps that service technicians complete to perform the service of the specific service type. The service system sends the instance records to client devices associated with technicians to aid the service technician in performing services of the corresponding service type for customers according to the corresponding service steps.

The service system also allows for the customization of instance records for customers. In particular, the service system allows administrators or service technicians with appropriate permissions to view and modify the instance records by modifying or adding to the hierarchy of service steps at a service type level for the customer. For example, a service technician is able to adjust the service steps from the origin template to reflect the needs of a customer at the service type level. Added service steps at the service type level synchronize with the service system to update customer service profile information for the customer, such that the service system can apply the changes to each instance of service according to the needs of the customer.

Furthermore, the service system allows for the customization of instance records at an instance level. Specifically, customizations to the instance records at an instance level apply only to the particular instance indicated. For example, the service system applies modifications or additions to the service steps at the instance level to an instance record for performing a single instance of the service, rather than to multiple instances. Thus, the service system allows for the customization of instance records with respect to a plurality of customers of a service type, to individual customers, or to individual instances of the service.

As described herein, the service system provides advantages over conventional service systems. The service system generates instance records using a plurality of different template levels to customize the instance records. By using different levels of templates, the service system is able to provide customization that ensures uniformity of services for each service type while also allowing customizability that satisfies customers' needs. Additionally, the service system provides simple, consistent management of service technician performance and service reporting.

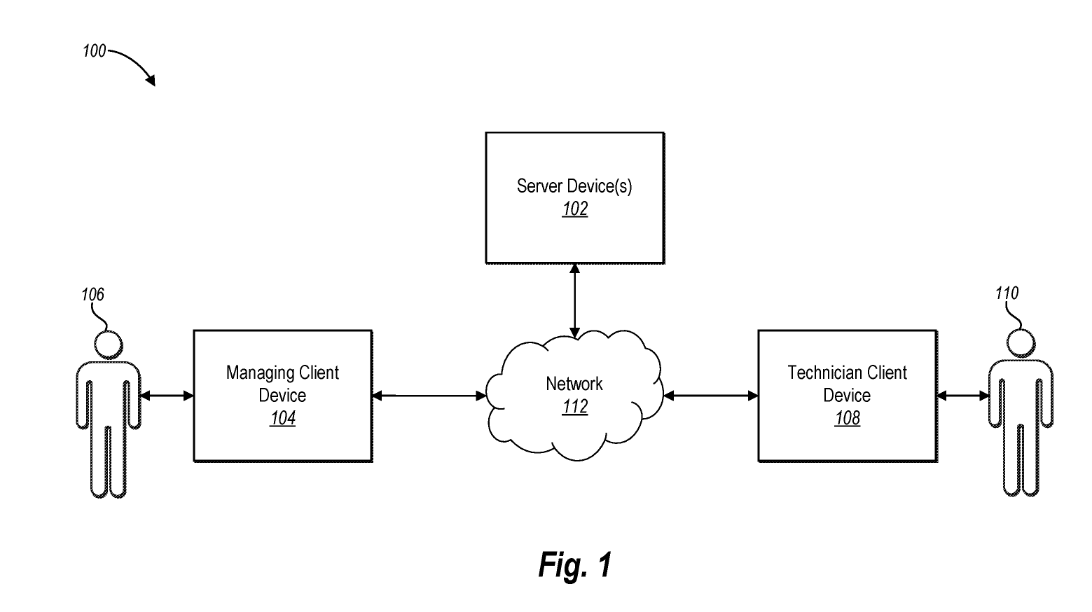

FIG. 1 illustrates a schematic diagram of a service system 100. The description associated with FIG. 1 provides an overview of the service system 100. A more detailed description of the components and processes of the service system 100 are provided in relation to the remaining figures.

The service system 100 allows a service provider to provide on-site services to customers. As used herein, the term “on-site service” refers to a service performed at a site specified by a customer. For example, an on-site location for an on-site service can include a residential or commercial location that a customer specifies in a service request. To illustrate, a service provider can provide an on-site service to a customer's home, place of business, or other location as indicated by the customer. As used herein, the term “service provider” refers to an entity that provides on-site services for customers. To illustrate, a service provider can include a business entity that provides pest control services; lawn care services; in-home repair, maintenance, or cleaning services; utility services; or other on-site services.

The service provider provides on-site services via service technicians that travel to the on-site locations. As used herein, the terms “sales technician,” “service technician,” and “technician” refer to a person who performs services for a customer. Specifically, a service technician can include an employee of the service provider or a sub-contracted technician who performs services for customers as indicated by the service provider. In one or more embodiments, a sales technician includes a sales representative who sells services for a service technician to perform. Alternatively, a single technician can perform both sales and services for a customer.

According to one or more embodiments, the service system 100 manages and communicates with technicians to provide services to a plurality of customers. FIG. 1 illustrates that the service system 100 includes server device(s) 102, a managing client device 104 associated with a manager 106, and a technician client device 108 associated with a technician 110. The service system 100 allows the server device(s) 102 to store and manage data associated with communications between the managing client device 104 and the technician client device 108 by communicating with the managing client device 104 and technician client device 108 via a network 112. Although FIG. 1 illustrates a single managing client device 104 and a single technician client device 108, the service system 100 can allow the server device(s) 102 to communicate with any number of managing client devices and/or technician client devices, as may serve a particular embodiment.

In one or more embodiments, the server device(s) 102 include one or more computing devices that collect, use, and store data associated with on-site services. For example, the server device(s) 102 can include a plurality of computing devices connected via a local network. The server device(s) 102 can be servers that are used primarily or exclusively to collect, use, and store data associated with on-site services, including service performance information, technician information, and customer information. Alternatively, the server device(s) 102 can be part of a larger system capable of performing service management tasks, as well as other tasks related to the provision of on-site services and/or management of a business entity.

In one or more embodiments, the managing client device 104 is a computing device associated with a manager 106. For example, the manager can be an employer, administrator, or other management personnel who uses the managing client device 104 to manage the distribution of tasks to technicians and the performance of services by the technicians. The manager 106 can use information associated with services, technicians, and customers to determine how to distribute a workload to technicians, how to assess the performance of the technicians, and how to perform services to meet the needs of customers. Additionally, the manager 106 can create new service templates (i.e., origin templates, service type templates, and instance templates) or modify existing service templates using the managing client device 104 for use in generating instance records for different service types. As used herein, the term “instance record” refers to a digital record that includes a hierarchy of service steps for performing a service. For example, an instance record can include an expandable/collapsible list of service steps that a technician is required to follow to complete the service.

The technician client device 108 is a computing device that allows a technician 110 to perform operations related to on-site services. Specifically, the technician 110 can view instance records using the technician client device 108 and interact with the instance records in a variety of ways. For example, the technician 110 can complete services using the instance records by interacting with the hierarchy of service steps as the technician 110 completes the service steps via a user interface displayed on the technician client device 108. Additionally, the technician 110 can modify the service steps or add new service steps within the hierarchy of service steps via the user interface on the technician client device 108.

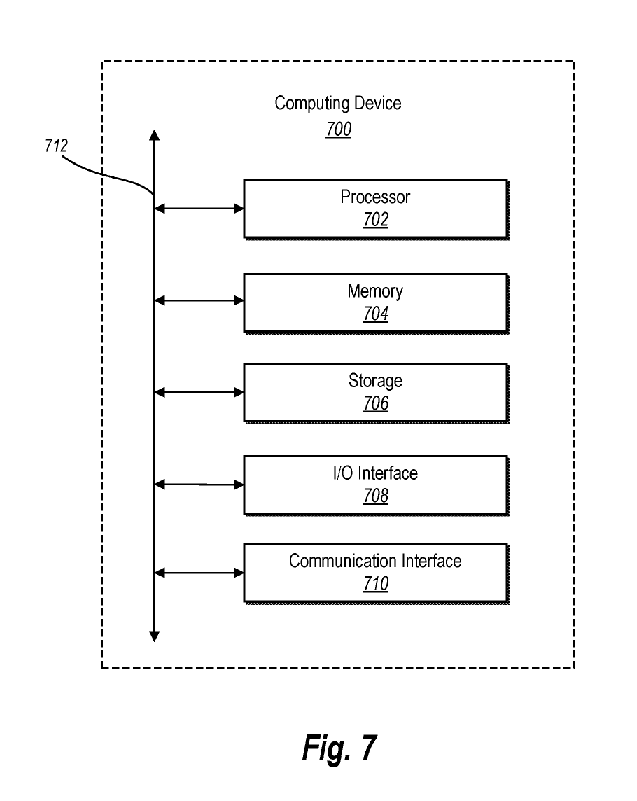

In one or more embodiments, the client devices (i.e., the managing client device 104 and the technician client device 108) are computing devices that allow the manager 106 and the technician 110 to receive, view, and interact with service information (e.g., instance records, templates, customer service profiles). For example, the client devices 104, 108 can include mobile computing devices (e.g., smartphones, laptops, tablets), desktop computing devices, or other computing devices that include software capable of receiving marketing communications, as described in more detail in FIG. 7. Specifically, the technician client device 108 can include a mobile computing device that allows the technician to view and interact with instance records while performing an on-site service. To illustrate, the client devices can run service software that allows the client devices 104, 108 to send and receive service information. Thus, the server device(s) 102 can communicate with the managing client device 104 and the technician client device 108 via the service software to send and receive service information.

As described, the network 112 can include one or more private and/or public networks that use various communication technologies and protocols. Specifically, the server device(s) 102 may communicate with the managing client device 104 via a first connection with a first connection type (e.g., LAN). The server device(s) 102 may communicate with the technician client device 108 via a second connection with a second connection type (e.g., Internet). In at least some embodiments, the technician client device 108 does not communicate directly with the managing client device 104 via the network 112, though other embodiments and/or configurations of the service system 100 may allow the technician client device 108 and the managing client device 104 to communicate via the network 112.

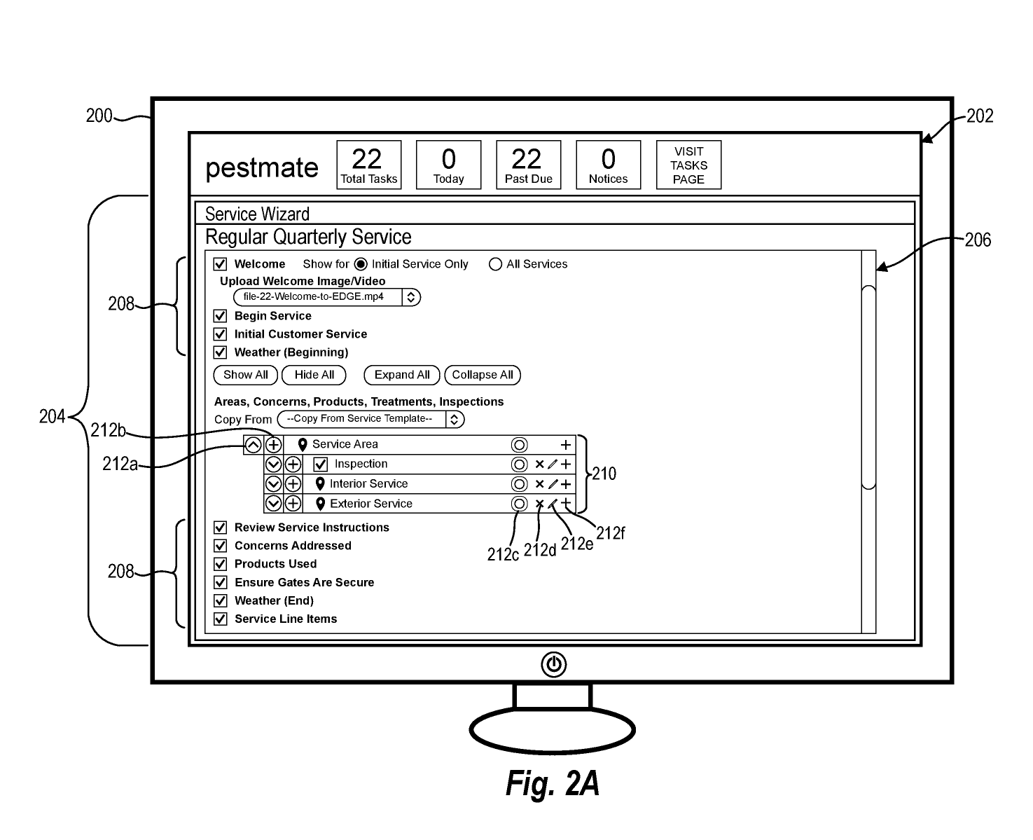

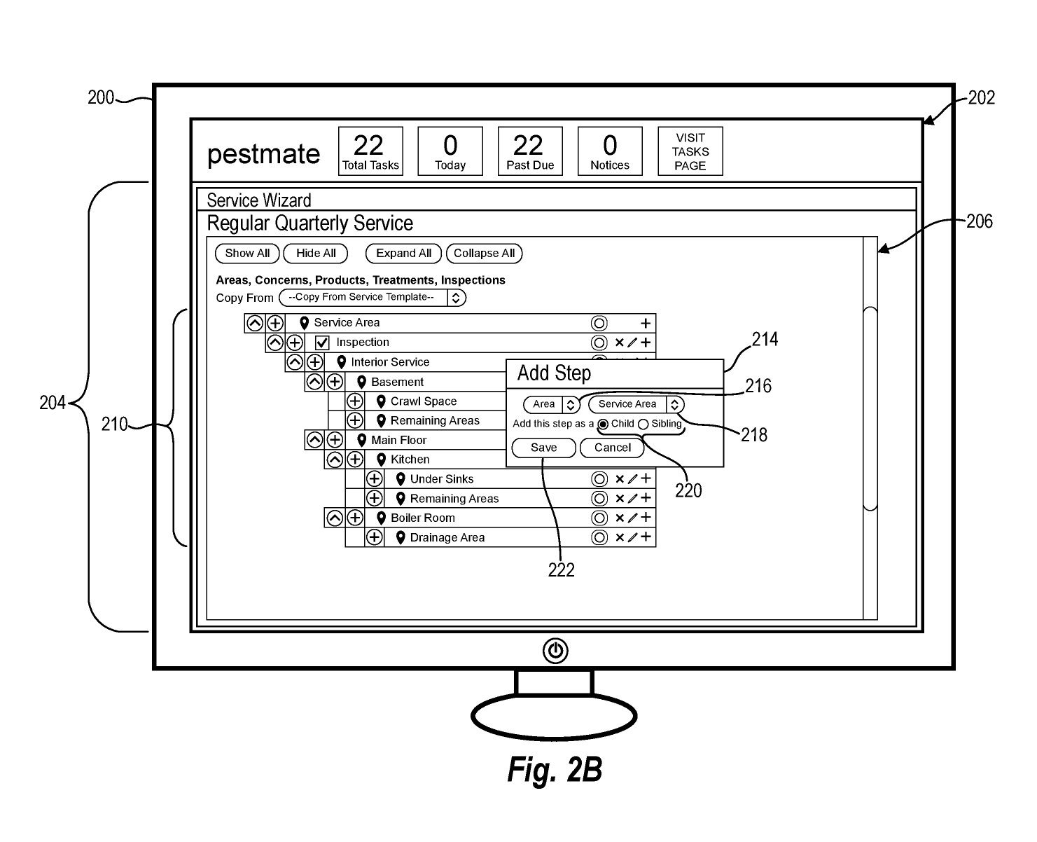

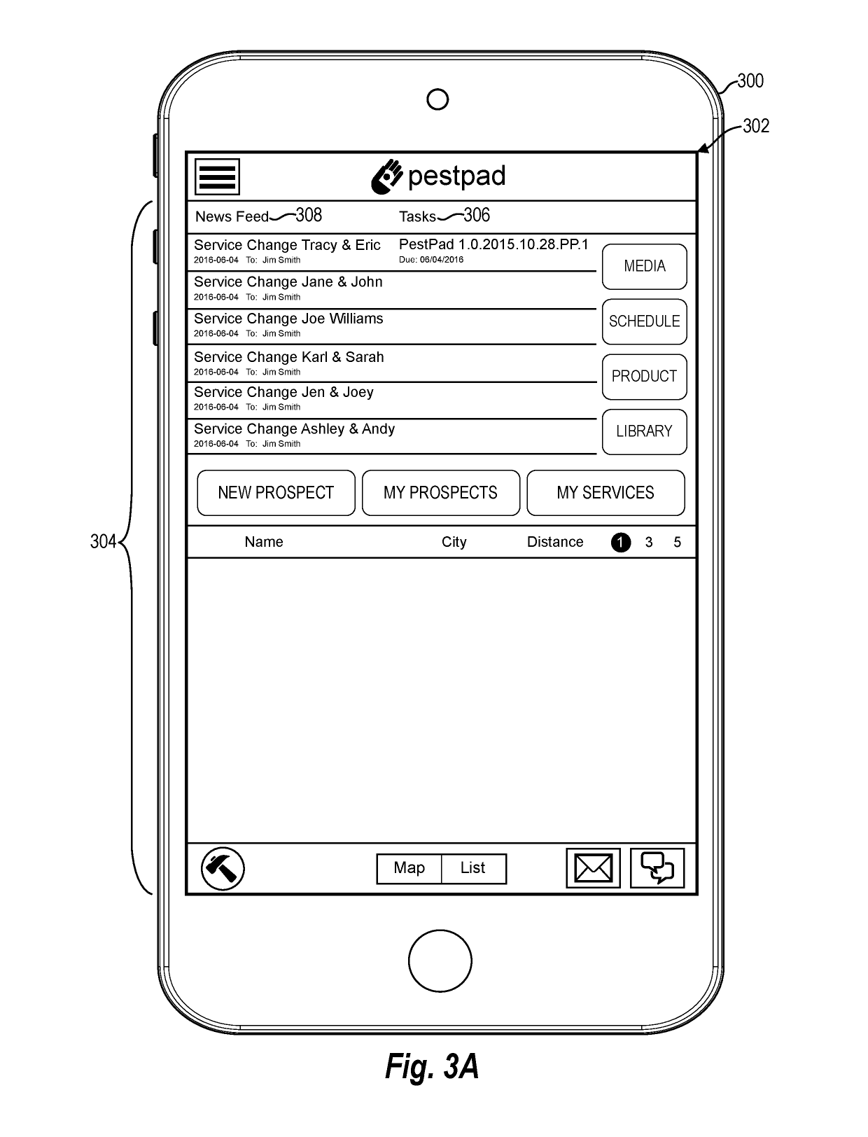

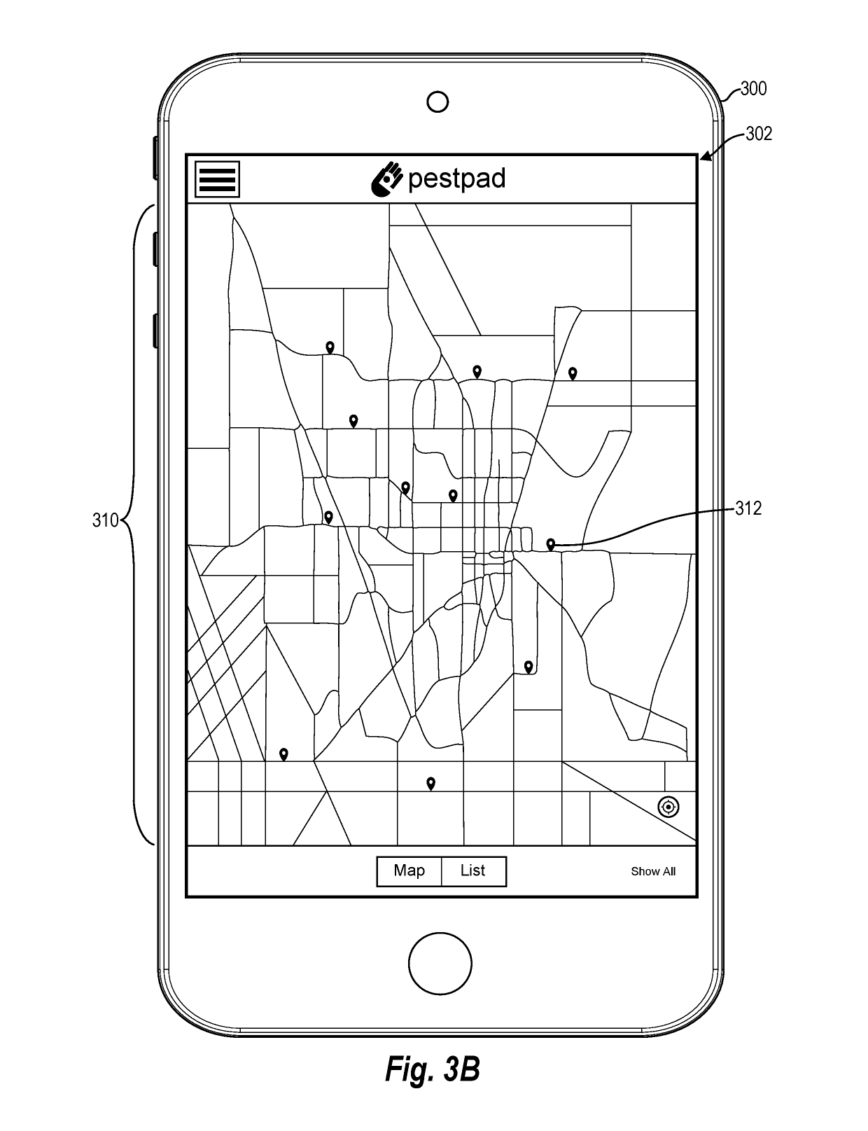

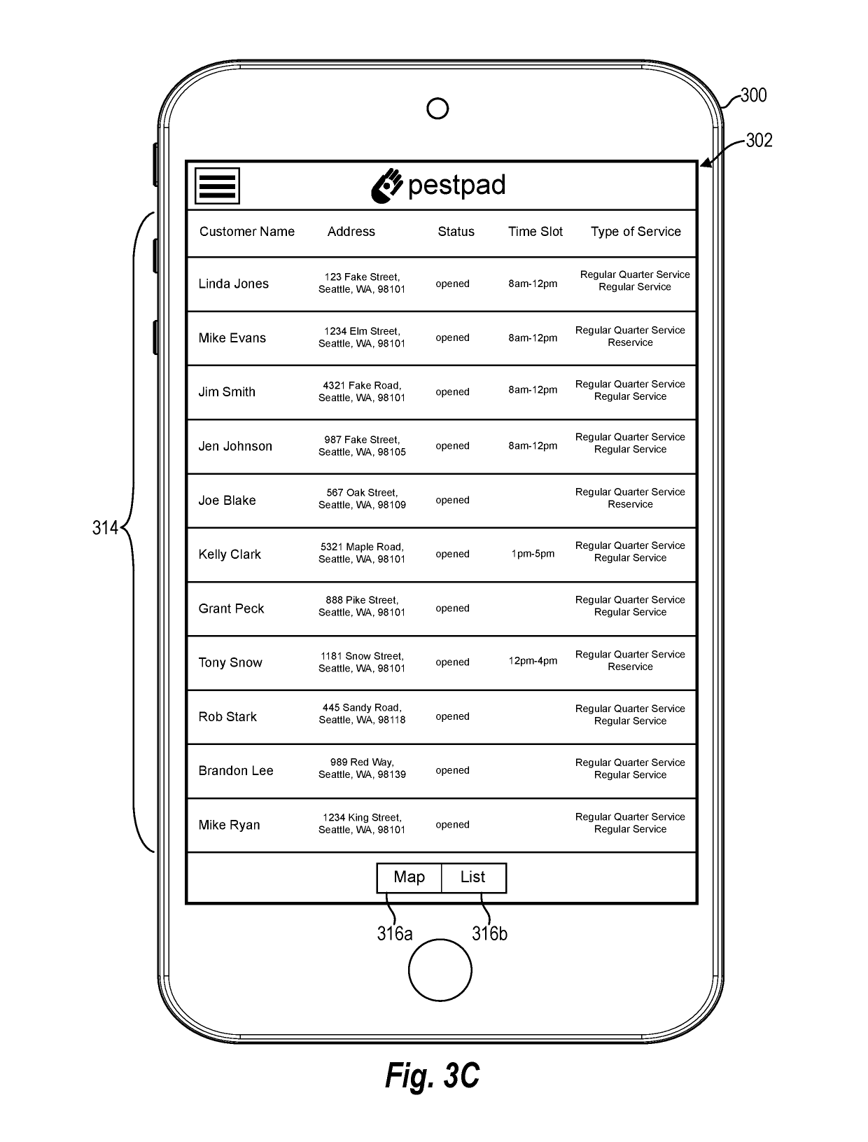

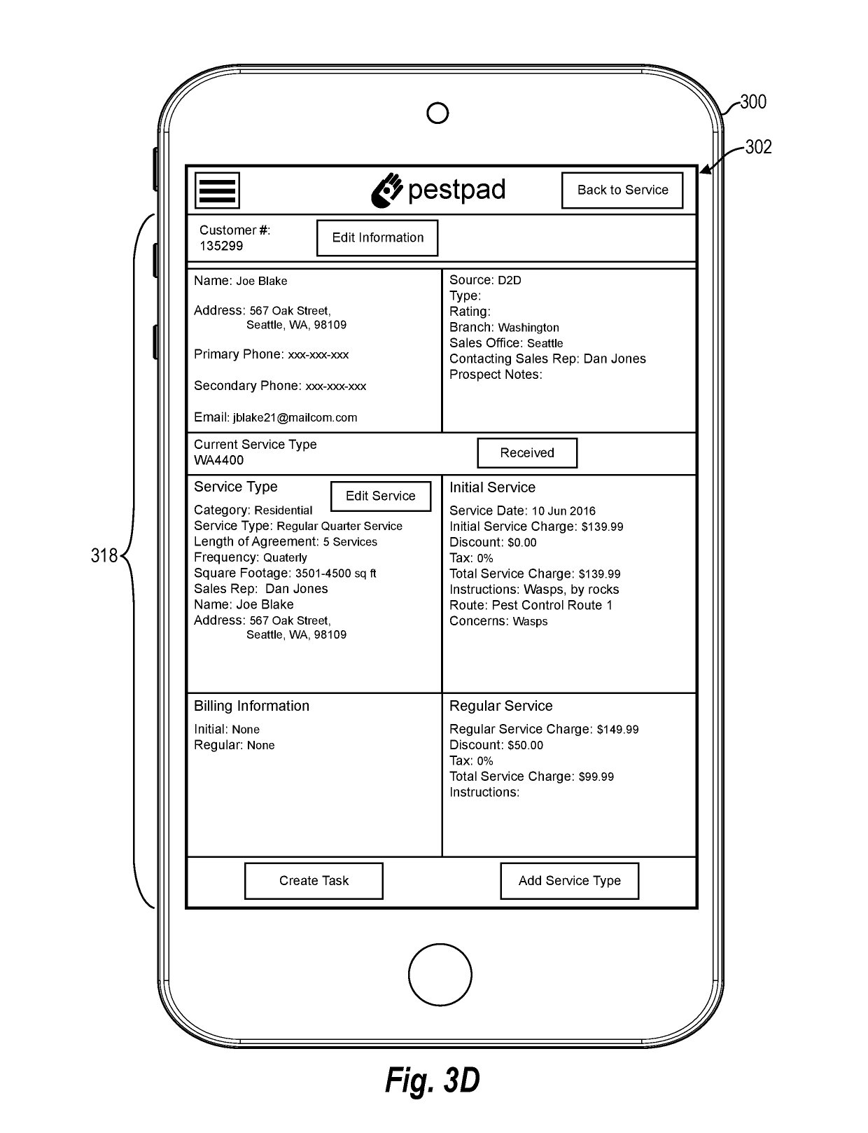

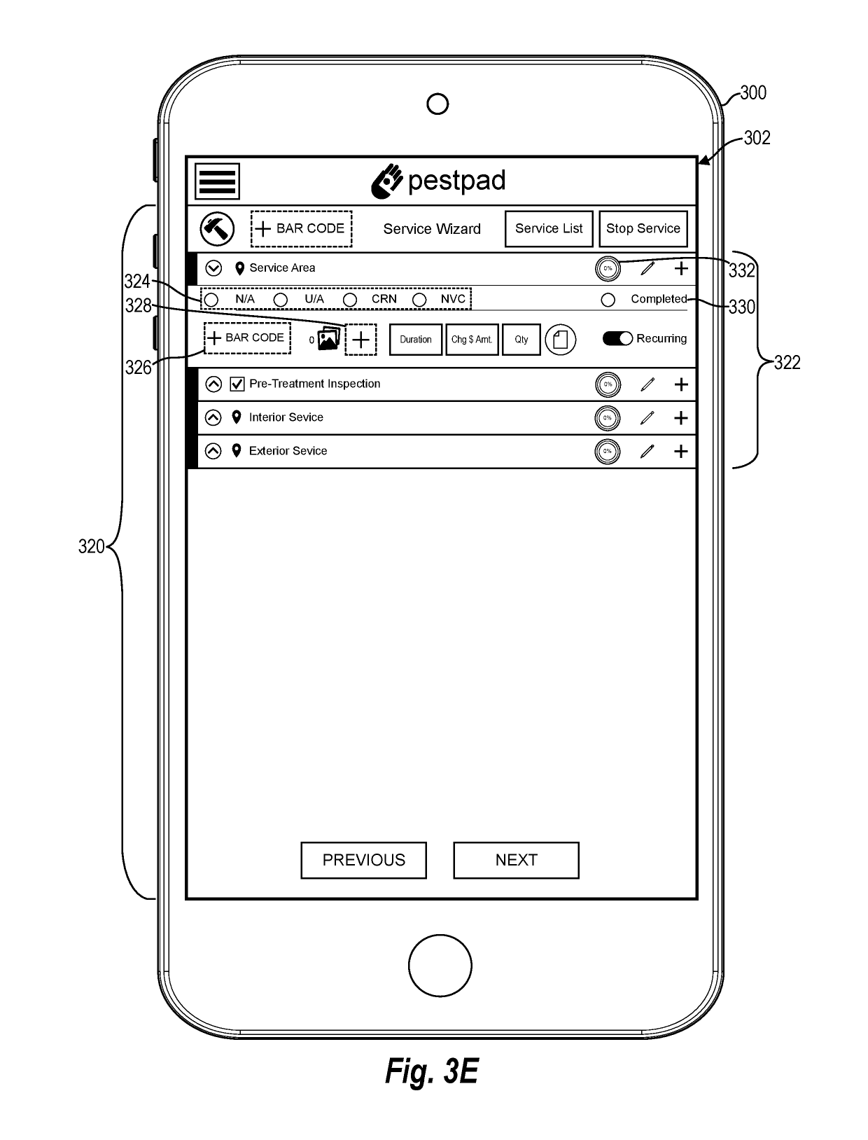

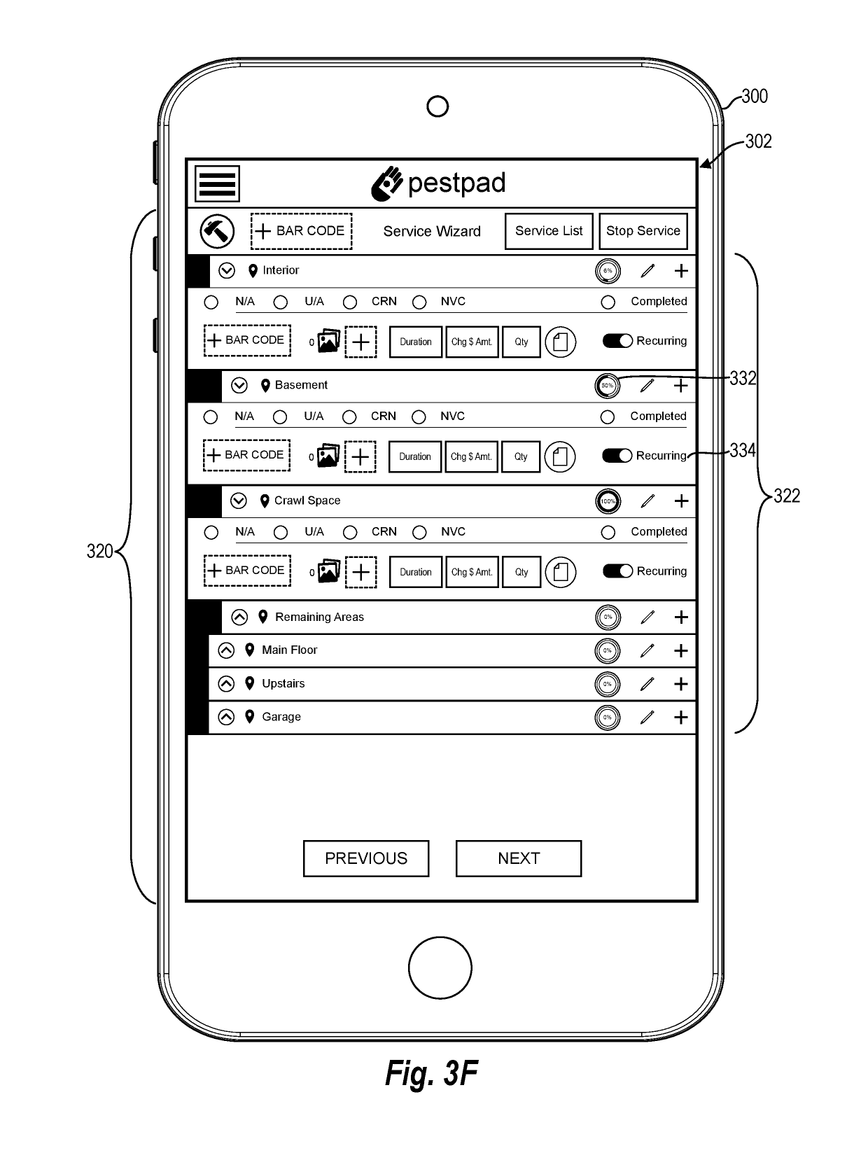

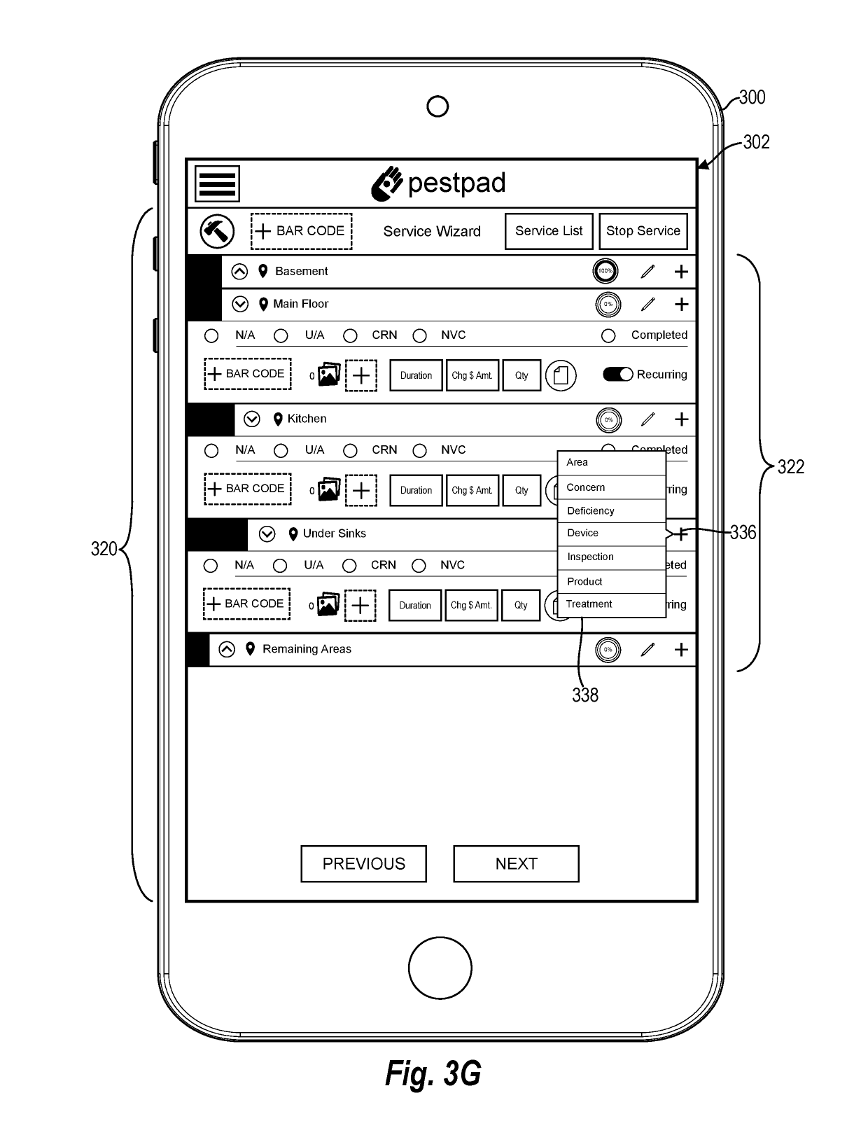

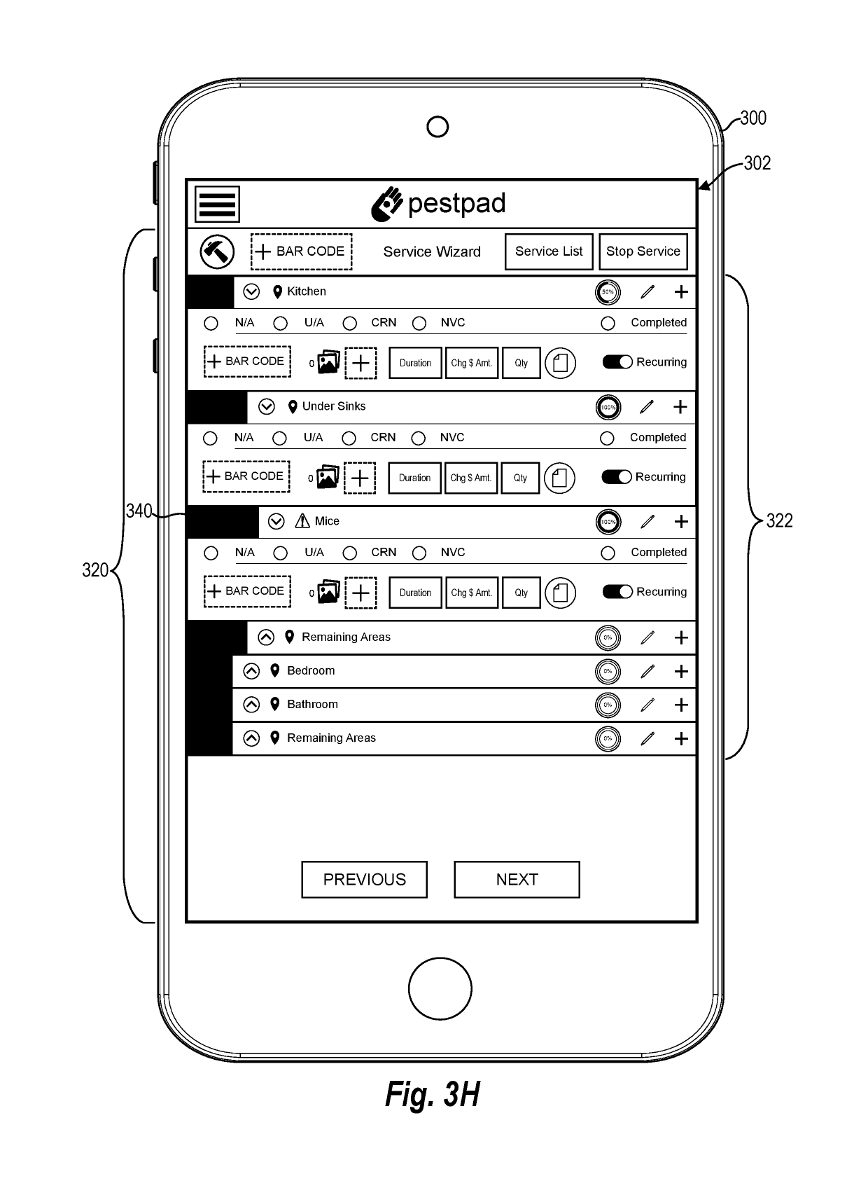

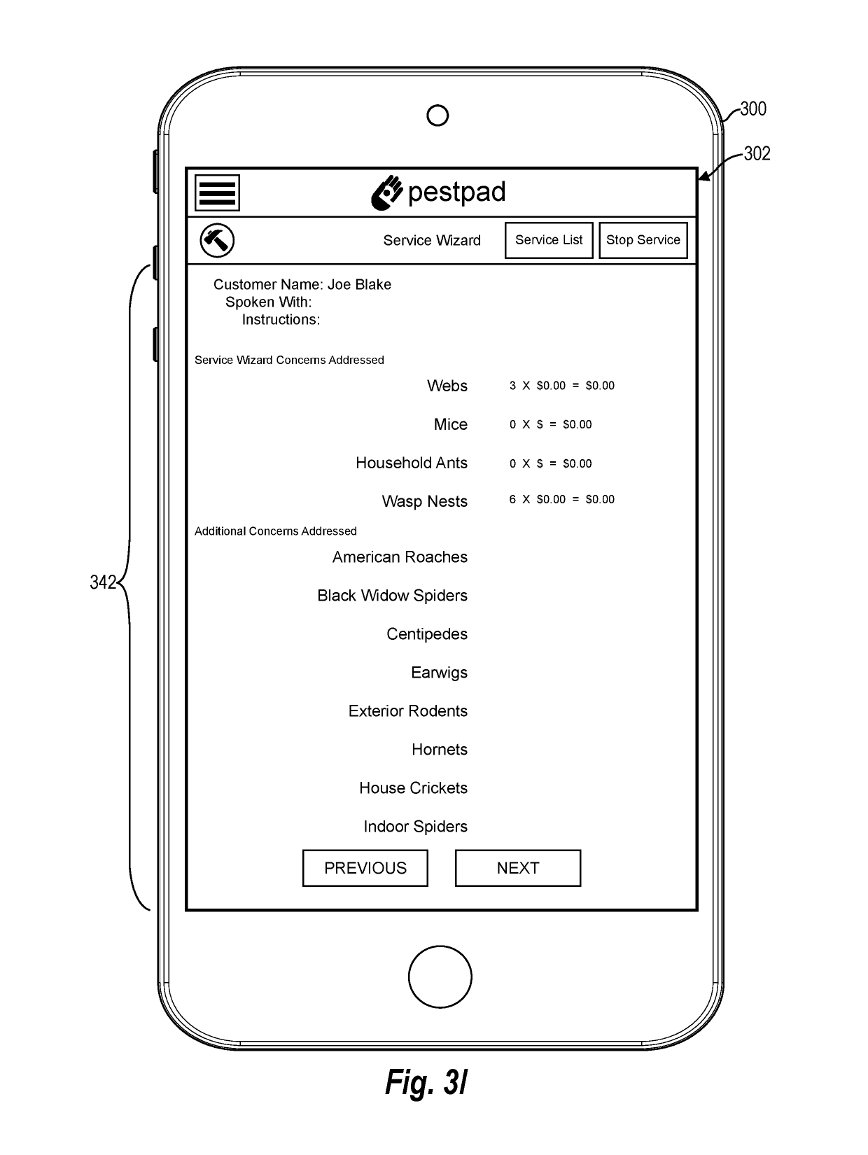

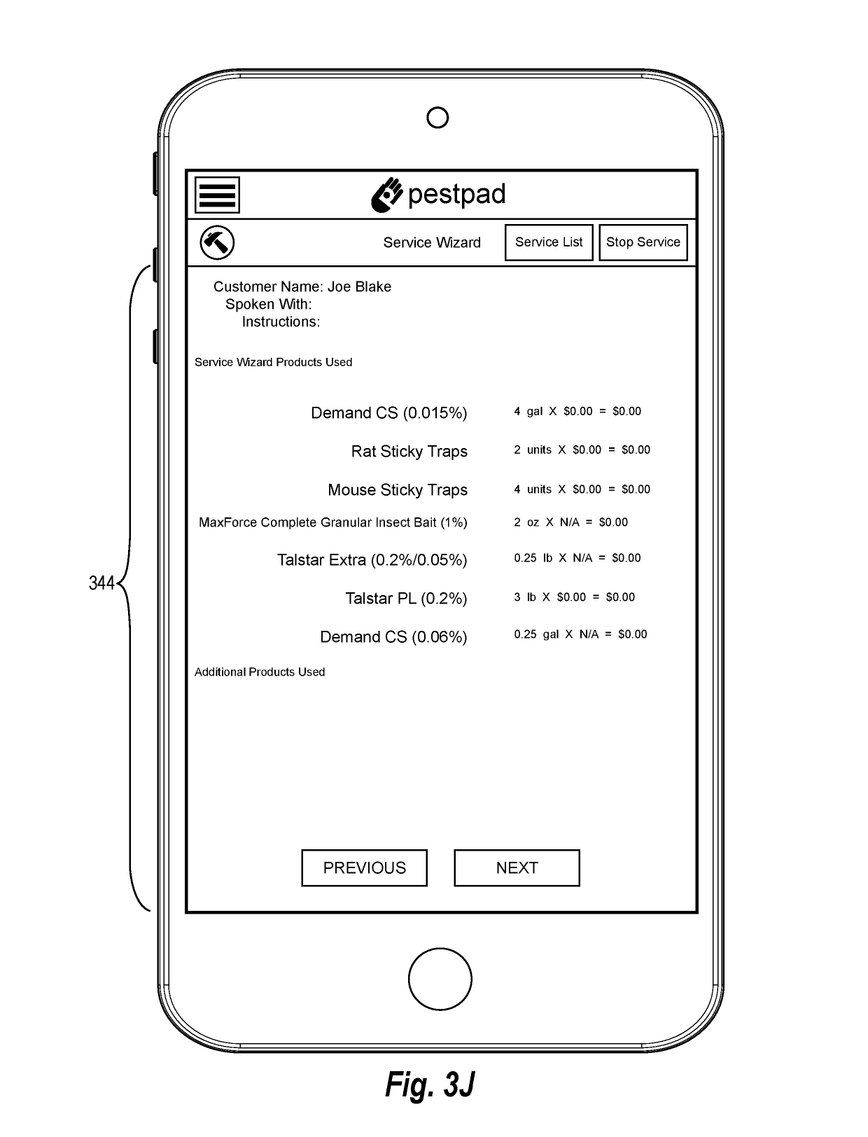

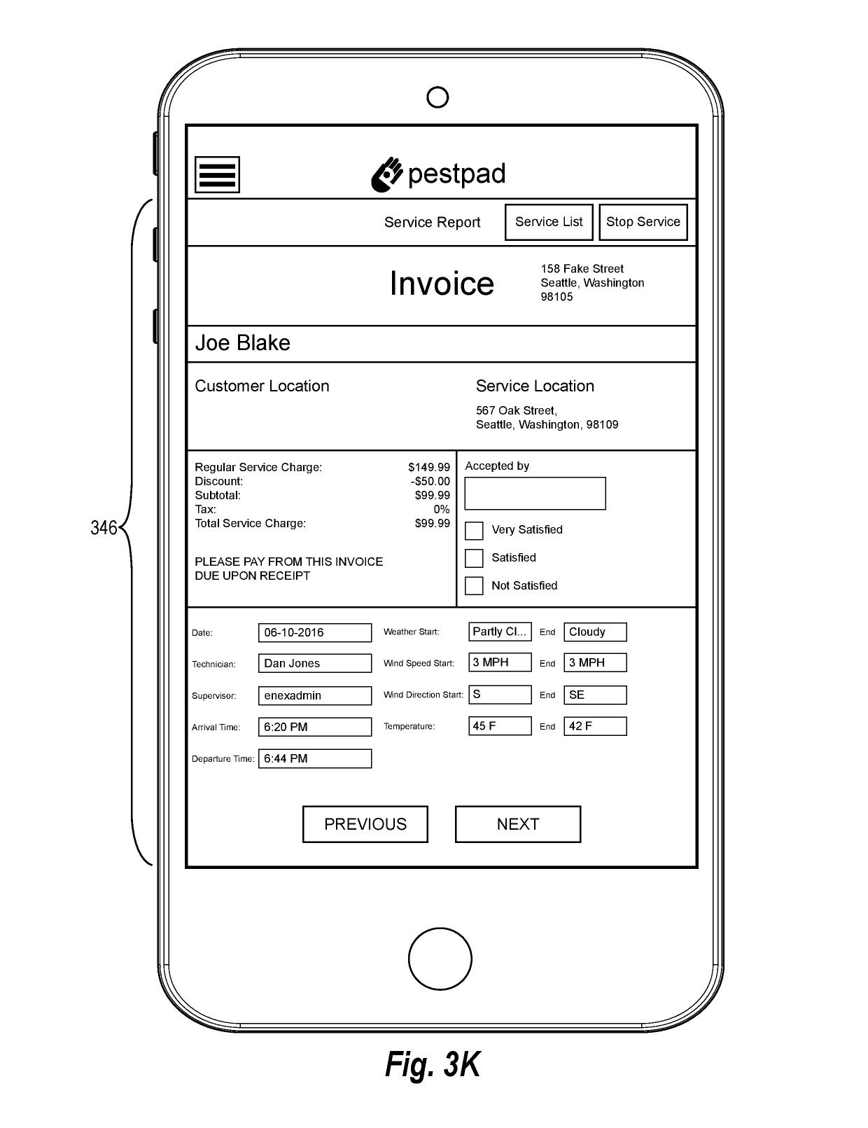

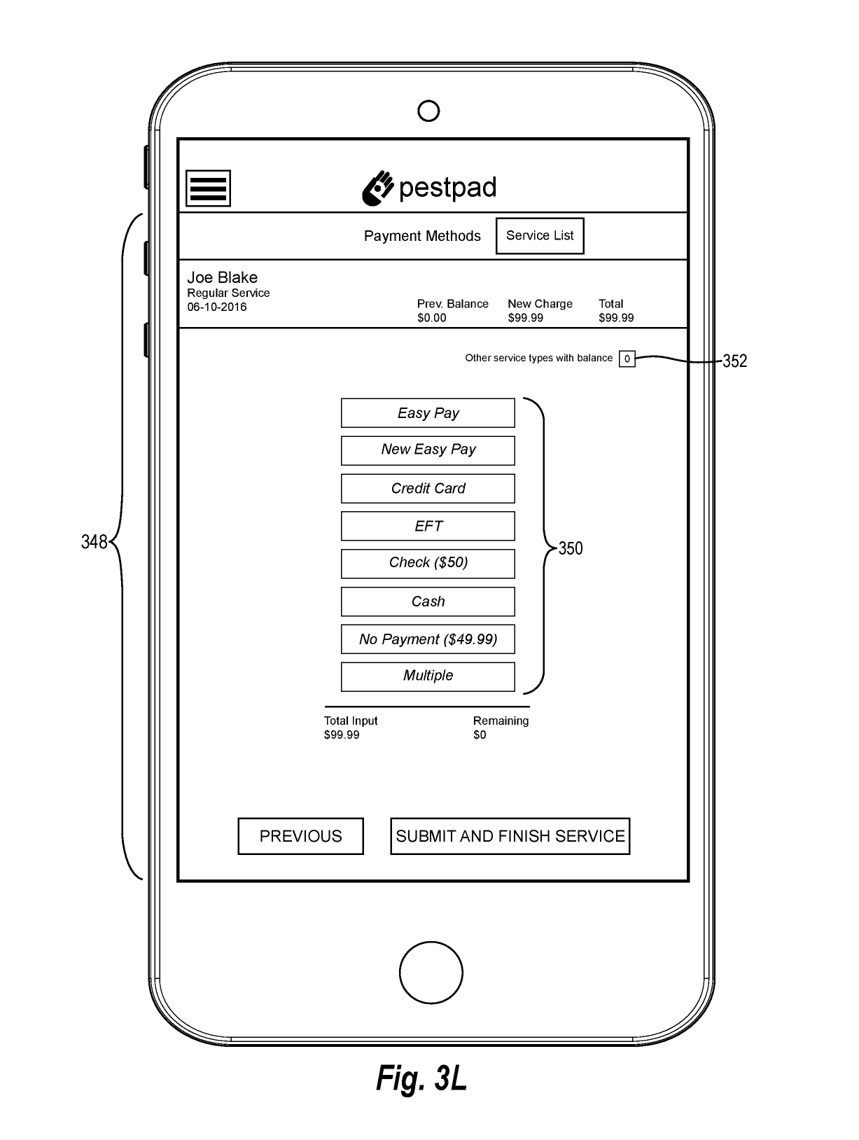

As discussed, the systems and components discussed above with reference to FIG. 1 allow a service system to transmit, collect, and store service information related to on-site services for customers. Specifically, the service system 100 uses the service information to provide customized services to customers while also creating uniformity, simplicity, and accountability in technician service performance and reporting. FIGS. 2A-2B and FIGS. 3A-3L and the description that follows illustrate various example embodiments of the user interfaces and features of client applications that allow a manager and a technician to perform various operations related to generating and interacting with instance records for performing on-site services.

For example, FIGS. 2A-2B illustrate various views of GUIs provided by a client application at a managing client device to facilitate the generation of templates for creating instance records. In particular, FIGS. 2A-2B illustrate user interfaces for service software that allows a manager (e.g., of a service provider) to create service templates so that the service system can generate instance records, which technicians then use in providing services to customers. Additionally, FIGS. 3A-3L illustrate various views of GUIs provided by a client application at a technician client device to facilitate the performance of on-site services. To illustrate, FIGS. 3A-3L illustrate user interfaces for service software on a mobile device that allows a technician to view an instance record for a customer and interact with the instance record to perform the service, as well as to customize the instance record by interacting with service steps, providing completion information for the service steps, or adding service steps.

As stated, FIGS. 2A-2B illustrate the managing client device 200. In one or more embodiments, the managing client device 200 includes a desktop computing device. Although the managing client device 200 of FIGS. 2A-2B is illustrated as a desktop computing device, the managing client device 200 can be another type of computing device that allows the manager to perform operations associated with the creation of templates and instance records for on-site services.

With reference to FIG. 2A, the managing client device 200 includes (e.g., runs) a client application 202 that allows a manager to view and interact with information related to on-site services. Specifically, the client application 202 can include service software that provides various interfaces to the manager for creating, viewing, and/or modifying templates for creating instance records. The client application 202 uses the templates (e.g., origin templates, service type templates, instance templates) to generate instance records for sending to technician client devices. As described in relation to FIG. 1, one or more server devices can store templates and other information used in creating instance records and for performing on-site services. Thus, after creating templates, the managing client device 200 can communicate with server devices to store the templates and to transmit instance records based on the templates to the technician client devices.

In one or more embodiments, the client application 202 allows a manager to create a template for a selected service type. For example, the manager can select a service type from a plurality of service types to create a template for the service type. Alternatively, the client application can allow the manager to create a new service type. After selecting an option to create a new template for a selected service type, the client application 202 displays a template interface 204 that includes information corresponding to an origin template 206 for the service type.

In one or more embodiments, the template interface 204 allows the manager to view information associated with origin templates, service type templates, and instance templates. According to one or more embodiments, the origin template 206 allows a manager to apply information to all instance records associated with a corresponding service type. For example, the manager creates the origin template 206 using the client application 202 on the managing client device 200 by selecting one or more service steps that services for the corresponding service type include by default. The managing client device 200 and/or the server devices then generate instance records for customers based on the origin template in response to receiving a request to perform a service of the service type from the technician client device. In one or more embodiments, each instance record created based on the origin template 206 for services of the service type includes the service steps from the origin template.

When creating the origin template 206 in the template interface 204, the manager can select from a plurality of different configuration options to include with the template 206. The template interface 204 in FIG. 2A includes a plurality of options for including information with the origin template 206 for a first service type (e.g., “Regular Quarterly Service” for pest control). Specifically, the template interface 204 includes selectable options for including information in each instance record sent to one or more technicians for completing services of the service type. In at least some implementations, the information includes pages and/or service steps to be included in each instance record based on the origin template 206.

In one or more embodiments, the template interface 204 can display a plurality of checkboxes 208 (or other selection mechanisms) associated with pages to include in the origin template. For example, a checkbox can be associated with a page that displays specific information to the technician during the performance of the service. To illustrate, each page in the origin template 206 can include information related to the performance of the service for a specific customer. For instance, a page can include, but is not limited to, a welcome page, one or more pages indicating information associated with the service or the customer, one or more weather pages for recording information about the weather at the time of the service, an instruction page, a concerns page, a products used page, a line items page, a documents page for attaching additional documents, a service review page, and a closing page. Additionally, or alternatively, one or more of the pages can comply with reporting requirements based on state or federal laws, industry regulations, or business standards associated with the service provider. Selecting a checkbox for a specific page causes the page to be included in instance reports based on the origin template, while deselecting the checkbox causes the page to be omitted from the instance records based on the origin template 206.

In one or more embodiments, the template interface 204 also displays a hierarchy structure 210 including service steps to include in the origin template 206. In particular, the hierarchy structure 210 can include an editable hierarchy structure that includes all of the service steps a technician performs when performing the service. For example, the template interface 204 allows the manager to edit the hierarchy structure 210 by adding service steps, removing service steps, and modifying service steps (e.g., by moving service steps within the hierarchy structure or changing names of the service steps).

The hierarchy structure 210 can include one or more parent nodes, child nodes, and sibling nodes based on the relationship of each service step to other service steps. For example, FIG. 2A illustrates a parent node (“Service Area”) that includes a plurality of child nodes (“Inspection,” “Interior Service,” and “Exterior Service”). Because the parent node includes a plurality of child nodes, completion of the parent node is based on completion of the child nodes. Additionally, each child node can be a parent node to one or more additional child nodes, etc. By including service steps with specific parent/child/sibling relationships in the hierarchy structure 210 of the origin template 206, the manager causes the service system to include the service steps with the same parent/child/sibling relationships in the instance records based on the origin template 206.

In one or more embodiments, the template interface 204 includes one or more options that allow the manager to view information associated with or to interact with the hierarchy structure 210. Specifically, as illustrated in FIG. 2A, a service step in the hierarchy structure can include an expand/collapse element 212a, a detail editor element 212b, a template indicator element 212c, a delete element 212d, a step editor element 212e, and an add step element 212f For example, the expand/collapse element 212a, if applicable, allows the manager to expand or collapse the service step for viewing or hiding child steps of the service step. The detail editor element 212b allows the manager to edit details about the service step, including required duration, charge amounts, quantities, or media items associated with the service step. The template indicator element 212c indicates which template the service step belongs to—i.e., origin (“o”), service type (“s”), instance (“i”), add-on (“a”). The delete element 212d allows the manager to delete the service step and any child nodes of the service step from the hierarchy structure 210. The step editor element 212e allows the manager to edit a name and/or type of the service step. The add step element 212f allows the manager to add additional service steps related to the selected service step to the hierarchy structure 210.

As mentioned, the template interface 204 allows the manager to add new service steps to the hierarchy structure 210. For example, selecting the add step element 212f causes the template interface 204 to display a dialog 214 for adding a service step to the hierarchy structure 210, as shown in FIG. 2B. In one or more embodiments, the dialog 214 is a pop-up window in the template interface 204. Alternatively, the client application 202 may display an option to add a new service step according to other display methods, as may serve a particular embodiment. For example, the client application 202 may display the option to add a new service step in a separate interface.

In one or more embodiments, the dialog 214 to add a new service step allows the manager to add a service step from a predetermined list of service steps associated with a predetermined type of service step to the hierarchy structure 210. In particular, the dialog 214 can include a first dropdown menu 216 to select a type of service step to add to the hierarchy structure 210. For example, FIG. 2B illustrate the addition of a new area to the hierarchy structure 210 in the first dropdown menu 216. Adding a new area can indicate a new service area that a technician services while performing the service for a customer.

Although FIG. 2B illustrates the type of service step as an area, the dialog 214 can allow the manager to add from a plurality of different types, including, but not limited to area, deficiency, device, concern, inspection, product, and treatment. As an example, an area type indicates an area of the on-site location that a technician visits to perform the service. A deficiency type can relate to or include a concern or notable area that may cause issues related to the service, but which are not covered by the service (e.g., a structural issue that allows pests to enter a home). A device type can relate to or indicate a device that a technician uses in performing the service, such as a mouse trap, ant trap, etc. A concern type can relate to or indicate a pest, a problem area, or other issue associated with the service that is covered by the service. An inspection type can relate to a step or series of steps to do a visual inspection of the areas for which the technician will perform the service. A product type can indicate a product that a technician uses to treat an area, such as a liquid spray, granules, etc. A treatment type can indicate a type of action that a technician performs related to a service, such as knocking wasps nests down with an extension pole.

Additionally, the dialog 214 can include a second dropdown menu 218 to select a subtype of the type of service step to the hierarchy structure 210. Specifically, the second dropdown menu 218 can include a plurality of predetermined subtypes of the type of service step selected in the first dropdown menu. For example, selecting the type of service step as area in the first dropdown menu 216 causes the template interface 204 to populate the second dropdown menu 218 with a plurality of subtypes of areas from which the manager can select to associate with the new service step. To illustrate, the manager can select to add a new service area (basement, main floor, second story, etc.) to the hierarchy structure 210 at a specific location.

As illustrated, the template interface 204 also allows the manager to select the type of relationship that the new service step will have with the indicated service step. For example, the dialog 214 to add a new service step can include a selectable option 220 (e.g., a radio button) to add the new service step as a child or as a sibling step. Once the manger has selected type, subtype, and relationship type of the service step, the manager can select a save element 222 to add the service step into the hierarchy structure 210. The new service step then appears in the hierarchy structure 210 in the template interface 204 with the characteristics selected by the manager.

In one or more additional embodiments, the template interface 204 allows the manager to copy a hierarchy structure from another origin template associated with a different service type. For example, the manager can copy a plurality of service steps (and the corresponding relationships) from another origin template if the other origin template has a similar hierarchy structure 210 to the origin template 206 the manager is creating. The manager can then modify the hierarchy structure 210 as desired to finalize the origin template 206. Thus, the client application 202 provides a quick and easy solution for creating a new origin template 206 by allowing the manager to use at least one other origin template 206 as a starting point.

According to one or more embodiments, the client application 202 also provides additional interfaces at the managing client device 200 for further customization of templates. For example, the client application 202 can include an interface that allows the manager or other user to view and/or edit predefined types/subtypes of service steps. Specifically, the client application 202 can allow a user to create types/subtypes of service steps for populating the dropdown menus used in adding new service steps to a template. Additionally, the client application 202 can allow the user to modify or delete existing types/subtypes of service steps. Thus, if the service provider adds new services or otherwise changes service options, the client application 202 allows a user to modify the predefined types/subtypes of service steps accordingly.

According to one or more additional embodiments, the client application 202 also allows a manager to set characteristics for the origin template 206. In particular, the characteristics can determine the service type associated with the origin template 206, as well as additional information about the service type. For example, the characteristics can include, but are not limited to, the service industry (e.g., pest control), how invoices are created, service charges (e.g., for initial and/or subsequent services), frequency, months for performing the service, time between services, number of services, notification methods, and service contract length. The characteristics set by the manager can affect the information displayed to technicians in one or more of the pages of the instance records when completing services for customers.

In one or more embodiments, the client application 202 also provides origin templates for add-on services. Specifically, the client application 202 can allow a manager to create add-on templates that include a plurality of service steps associated with completing a service that a technician can add on to another service at the request of a customer. For example, the manager can create a separate template that includes a hierarchy structure including service steps associated with the add-on service and store the add-on template as a separate template. The service system uses the add-on template to create and/or modify an instance record by including the hierarchy of service steps from the add-on template in the instance record.

Although FIGS. 2A-2B illustrate an embodiment in which a manager creates an origin template 206, the client application 202 can also allow the manager to create additional templates, such as service type templates. In one or more embodiments, a service type template allows a manager to customize instance records for a specific customer. Specifically, the service type template modifies a hierarchy structure in an origin template to create customized instance records for the customer. For example, the manager can modify an origin template associated with a service type by adding one or more service steps to the hierarchy structure. Adding new steps to the hierarchy structure for performing a service for a particular customer adds the service steps to the service type template. By adding new service steps that are applicable to a specific customer to a service type template, the service system only includes the added service steps in instance records for the specific customer.

In one or more embodiments, the service type template can include customizations based on a customer service profile for a customer. For example, the service type template can include additional service steps based on a layout of the customer's on-site location. Additionally, the service type template can include additional, or alternative, service steps based on the customer's geographic location. To illustrate, customers in certain locations may have different needs (e.g., pests unique to certain geographic areas), such that the service type template modifies the origin template according to the customer's needs.

Additional embodiments of the client application allow the manager to create and/or use an instance template to customize instance records for specific performances (i.e., instances) of a service. In particular, the instance template includes service steps that apply to an instance record associated with a single service for a specific customer. For example, the instance template includes one or more service steps that are not included in either the origin template or the service type template. Thus, the client application can allow a manager to customize instance records at different levels corresponding to specific service types, customers, or service instances using different templates.

In one or more embodiments, service type templates and instance templates modify the corresponding origin templates on a per customer basis. Specifically, the service system can store information from a service type template and/or an instance template with customer profile information for the customer. For example, the service system can associate the service type template and/or the instance template with the origin template using reference numbers or pointers that link the templates together. Linked templates cause the service system to include information from all of the linked templates when creating an instance record. To illustrate, the service system can add service steps from service type templates and/or instance templates to the hierarchy of service steps from an origin template when creating an instance record.

In one or more alternative embodiments, the service system uses a service type template and/or an instance template to modify an origin template. In particular, the service system can use the information from the service type template and/or the instance template to modify the origin template to include the information from the service type template and/or the instance template. For example, the service system can insert the service steps from the service type template and/or the instance template into the origin template at one or more positions based on user input from the manager. In one or more implementations, the service system differentiates service steps from different templates so that the manager can identify service steps that correspond to different templates, which allows the manager to easily manage the templates and modify the templates.

After setting up an origin template for a service and/or any service type templates or instance templates for specific customers, the service system can generate an instance record based on the origin template. In particular, the service system generates an instance record in connection with a service for a customer. FIGS. 3A-3L illustrate various views of GUIs on a technician client device 300 for providing an on-site service for a customer. Specifically, a technician can use the technician client device 300 with a client application 302 that displays the interfaces of FIGS. 3A-3L to allow the technician to provide the service.

As previously mentioned, FIGS. 3A-3L illustrate a technician client device 300, which, in the illustrated embodiment, is a handheld device. As used herein the term “handheld device” refers to a device sized and configured to be held/operated in a single hand of a user. For example, the technician client device 300 can include a smartphone, a tablet computing device, or other mobile computing device that allows the technician to carry the technician client device 300 as the technician performs an on-site service for a customer.

In one or more embodiments, the technician client device 300 includes a client application 302 that allows a technician to view and interact with information related to on-site services. Specifically, the client application 302 can include service software corresponding to the service software on the managing client device that provides various interfaces to the technician for viewing, modifying, and/or completing instance records associated with providing services to customers. The technician client device 300 receives instance records from one or more central servers based on an origin template for the service type of the service that the technician is performing.

Additionally, because the technician client device 300 can be a handheld device, the technician can use the client application 302 while performing the on-site services. For example, the technician can view each service step to perform for the service in the client application 302 and perform each service step according to the instance record. To illustrate, a pest control technician can perform inspections and/or treatments while using the technician client device 300 to verify the requirements associated with the service steps. The technician client device 300 can also include phone capabilities to allow the technician to communicate by phone with a manager, other technicians, and/or customers.

Additionally, the technician client device 300 can synchronize information associated with providing the on-site services so that the manager or other user can monitor the services while the technician performs the services. Specifically, the client application 302 can allow the technician to interact with the instance records to enter completion information or other information associated with providing the on-site services. For example, after entering the information, or at predetermined intervals, the technician client device 300 can synchronize with the managing client device (e.g., via the server devices) to transfer information about the service being performed that was collected on the technician client device 300 to the managing client device 104 and allow the manager to view the progress of the services, as described in more detail below.

With reference to FIG. 3A, the client application 302 can include a main interface 304. In one or more embodiments, the main interface 304 displays information corresponding to tasks and notifications for the technician. Specifically, the main interface 304 of FIG. 3A includes a task list 306, a news feed 308, information about customers (e.g., a prospective customer list), and navigation controls for viewing additional interfaces in the client application. Additionally, the main interface 304 can include other controls for software operations, including, but not limited to, elements for communicating with other technicians, managers, and/or customers, viewing settings, reporting bugs with the software, viewing media/instructions associated with providing services, and clocking in/out of a payroll system.

For example, the task list 306 can include a list of tasks assigned to the technician. For example, the task list 306 can include services that the technician has yet to perform. The task list can include tasks organized by date/time to be performed, such that the next service appointment chronologically is at the top of the task list, according to a time at which the technician enters the tasks, or according to any criteria specified by the manager and/or technician. Additionally, the task list 306 may include only a brief summary of the service appointments that the technician is to perform on the current day. Alternatively, the technician can access the services for the current day by way of another interface, as described in more detail below. In addition to services, the task list 306 can include additional tasks, such as administrative tasks or other business-related tasks. For example, the task list 306 can include a list of tasks not related to individual services for customers, such as servicing a technician's vehicle, contacting a manager about a customer, or verifying payroll information. In one or more implementations, the technician and/or another user (e.g., the manager) are able to set up tasks in the task list 306.

In one or more embodiments, the news feed 308 includes a plurality of notifications for the technician. Specifically, the news feed 308 includes information related to services, appointments, messages, or other notifications that are relevant to the technician. For example, the news feed 308 can notify the technician when an appointment has changed or when a new appointment is added to the technician's task list. To illustrate, if the service system assigns a new service appointment to the technician (e.g., reassigned from another technician due to timing issues or a newly scheduled service), the service system can send a notification to the technician client device 300 in the news feed 308.

As mentioned, the main interface 304 can include a plurality of navigational elements that cause the client application 302 to open and/or navigate to other interfaces. For example, the main interface 304 can include a services element that causes the client application 302 to display customers with service agreements. In one or more embodiments, selecting the services element causes the client application 302 to display a map interface 310, as illustrated in FIG. 3B. In particular, the map interface 310 includes a plurality of icons that indicate services that the technician has scheduled for the day, services that are pending, and/or services that are assigned to the technician. To illustrate, the map interface 310 includes an icon (e.g., a map pin 312) representing the location of each service in the map interface 310.

In one or more embodiments, the technician can select an icon to display additional details associated with the corresponding customer. For example, selecting an icon can display a summary of information about the customer in the map interface 310. To illustrate, the summary of information can include a pop-up window or dialog that includes a name of the customer and an address of the customer. Additionally, selecting the summary of information can cause the client application 302 to display a new interface with additional client information, including the details of the service (e.g., contact information, an appointment time, instructions for the service, and the type of service).

In one or more additional embodiments, the client application 302 also allows a sales technician to perform sales operations. Specifically, the client application 302 allows the technician to track information associated with the sales operations, such as visiting, contacting, and engaging in services with potential customers. For example, the map interface 310 can allow the technician to create and view elements (e.g., map pins 312) associated with sales information. To illustrate, the technician can use the map interface 310 to track a number of times that a technician has visited a specific location (e.g., a residential house), whether a person at the location is a potential customer, a customer, or whether the person has requested the technician not to visit. The map interface 310 can display different elements based on the type of event.

According to one or more embodiments, after visiting a location, the technician can create a visual element or indicator in the map interface 310 that indicates the type of visit (e.g., by selecting the visit type from an overlay menu). In particular, the technician can indicate that the technician visited a location using a first element (e.g., indicating a “knock event”). For example, if the technician visited the location, but did not make contact with a person at the location, the first element only indicates that the technician visited the location. For each time the technician visits the location, the technician can increment a number associated with the first element to indicate how many times the technician has visited the location without making contact (or without meeting a potential customer). The map interface 310 can display the number of visits that the technician or other technicians have visited the location.

The client application 302 can also allow the technician to set a time to revisit a location. Specifically, the technician can mark a “come back event” that reminds the technician to revisit the specific location by modifying the first element. For example, the technician can create the come back event to include a date and time reminder to remind the technician to revisit the specific location. The map interface 310 can modify the first element or create a new element to indicate the come back event associated with the time reminder. Additionally, the map interface 310 can allow the technician to input notes with the first element in connection with the knock event or the come back event.

In one or more embodiments, the client application 302 creates elements indicating knock events with different visual characteristics based on a distance from the technician's current location. Specifically, as a technician creates knock events or comeback events, the client application 302 can use the location of the technician client device 300 to determine how far away from the technician's current location a created event is at the time of creation. The map interface 310 can then display the created event with a different visual characteristic (e.g., color, shape, size) if the created event is outside a radius or threshold distance of the technician's current location. This can also indicate to the manager or other user that the technician is creating events far away from the technician's current location.

Alternatively, the technician can create a second element to indicate that technicians should not visit the location again. For example, if a person at the location requests that the technician no longer visit or the location includes a sign indicating that solicitors are not welcome, the technician can mark the location in the map interface with a second element. The second element can be a “don't come back” event that has a different appearance than the first element to readily indicate to the technician or to another technician not to visit the location in the future. The second element can stay in the map interface 310 permanently, for a predetermined amount of time, or until a person at the location explicitly requests a visit.

In additional, or alternative embodiments, the technician can indicate new prospective customers or convert knock events into prospective customers within the client application 302. For instance, a technician can create a new prospective customer from within the map interface 310 by selecting an option from an overlay menu. Alternatively, a technician can create a prospective customer from an existing visual element (e.g., a knock event) by selecting the visual element and selecting an option to create a prospect from the event. Selecting an option to create a prospective customer can cause the client application 302 to open a new interface where the technician inputs information. The technician can also indicate a rating associated with the prospective customer to indicate a likelihood of converting to a customer. The map interface 310 can indicate the rating by any visual characteristic (e.g., color, shape, size) as may serve a particular embodiment.

Creating a new prospective customer can also cause the service system to generate new customer profile information for the prospective customer. Specifically, if the prospective customer has a high likelihood of converting to a customer or if the prospective customer has asked for services without signing a service agreement at that time, the service system can generate a customer service profile for the prospective customer with personal information. Additionally, if the prospective customer has requested a service and provided personal information, the service system can generate a service agreement and/or an instance record for a first service to the prospective customer to send to the technician client device 300.

In one or more embodiments, the client application 302 allows the technician to view the customers with upcoming and/or recent services in a customer list. FIG. 3C illustrates a list interface 314 with a customer list that includes customer information for customers that have service agreements, customers that have services scheduled for the current day, services that are pending, services that are assigned to the technician, and/or for prospective customers for technicians attempting to convert people to customers. Specifically, the list interface 314 can be an alternative view of customer/service information displayed in the map interface 310. The technician can switch between the map interface 310 and the list interface 314 by selecting the corresponding map element 316a or list element 316b. As in the map interface 310, the list interface 314 allows the technician to select an entry corresponding to a customer to view additional client information and details of the service.

According to one or more embodiments, the interface that displays the additional client information and details of the service can include options to view service agreements and customer signatures and to begin the service. When the technician selects the option to begin the service, the client application 302 accesses the instance record (e.g., by downloading the instance record or accessing a local synchronized version of the instance record) for the service for the customer to allow the technician to perform the service. In at least some embodiments, the instance record affects the various interfaces available to the technician in connection with the current service. Specifically, the instance record causes the client application 302 to display interfaces corresponding to the selected pages to include based on the origin template, as described previously.

In one or more embodiments, beginning the service causes the client application to present an interface that displays an activity log for the customer. For example, the activity log can include a history of communications associated with the customer. To illustrate, the history of communications can identify attempts to contact the customer to perform one or more services for the customer, including whether someone from the service provider succeeded in contacting the customer and confirming the service, left a message, or failed to make any contact with the customer.

One or more embodiments of the client application 302 also allows the technician to input information about customer interactions in the client application. Specifically, the technician can verify whether the technician successfully contacted the customer. Additionally, the technician can specify a name of the person contacted. Alternatively, the technician can mark that the customer was not available, either allowing the technician to continue with the service or prohibiting the technician from continuing with the service due to the lack of a customer. In addition to information about customer interactions, the technician can also input other notes or information associated with the service, such as leaving a note in response to cancelling/suspending the service for the customer as to why the customer is stopping the service.

Additionally, the client application 302 can allow the technician to view detailed information associated with the customer. Specifically, the client application can display a customer profile interface 318 that includes customer profile information for the customer, as illustrated in FIG. 3D. For example, the customer profile information can include customer identification information, contact information, billing information, a servicing office, a contacting sales representative, and notes for the customer. Additionally, the customer profile interface 318 can display the services that the customer receives, including the service types and instructions for providing the services based on the customer's needs.

In one or more embodiments, after completing preliminary forms or information for the service, the technician starts the service. Specifically, the client application 302 displays a service step interface 320 that includes the service steps for performing the service in a “Service Wizard”, as illustrated in FIG. 3E. For example, the service step interface 320 includes a hierarchy structure 322 from an origin template that corresponds to the service type of the service. To illustrate, the service system generates the instance record shown on the technician client device 300 to include each service step in the hierarchy structure 322 from the origin template. Thus, the creator of the origin template can verify that the technician performs the service consistent with each other technician performing services of the same service type.

As shown, the hierarchy structure 322 is an expandable/collapsible structure that allows the technician to view more or fewer details about a service step and corresponding child steps while providing the service. For example, the service step interface 320 displays each parent node (i.e., service step with one or more child service steps) with an expand/collapse element that allows the technician to expand or collapse the corresponding node and any child nodes underneath the parent node. To illustrate, when the parent node is collapsed, the child nodes are hidden from view. Upon selecting the expand/collapse element, the service step interface expands the hierarchy structure to display one or more child nodes associated with the parent node. Additionally, selecting the expand/collapse element can change the appearance of the icon to indicate that the specific node is expanded.

In one or more embodiments, a service step also includes a plurality of options associated with the service step. Specifically, the service step can include options 324 that indicate an applicability of the service step to the current service. The technician can select one of the options 324 if the technician will not perform the service step for the current service for a specific reason. For example, the options 324 can indicate an applicability including a status of not applicable (“N/A”), unavailable (“U/A”), customer requested not to (“CRN”), or no visible concerns (“NVC”). Additionally, the technician can opt to hide a step if the step does not apply to the customer.

To illustrate, selecting an “N/A” status for a service step indicates that the service step is not applicable to the current service. For example, a service step labeled “Basement” may be not applicable if the corresponding location does not have a basement. A “U/A” status can indicate that the technician cannot perform a service for a particular area, for example, if the area is unreachable. A “CRN” status indicates that the customer has specifically requested that the technician not perform the specific service step. To illustrate, if the customer indicated that she did not want the interior service (e.g., for that service), the technician can select the “CRN” status for the service step. Additionally, the “NVC” status indicates that the area does not have any visible concerns. For example, during an inspection of an area, the technician can indicate that the given area has no visible concerns that the technician or customer needs to address. Alternatively, the statuses can apply to more than one service of the service type for that customer.

In additional embodiments, the service step interface 320 displays an option 326 to scan a bar code. In particular, the client application allows the technician to scan a bar code using an image capture device of the technician client device. For example, the technician can scan a code at a location (e.g., a bar code on a window of a customer's residence) of the on-site service to verify that the technician is at the location and performing the service. Thus, the service system can verify when each technician arrives at the location of a corresponding service to track the movement of the technicians and provide a notification if the technician is at the incorrect location. Additionally, the first time a technician performs a service, the technician can place the bar code at the location and scan the bar code to store the bar code with the customer profile information for use with future services.

The technician can also use the bar code to jump directly to a corresponding service step. To illustrate, a bar code can apply to a specific service step of a service, such that scanning the bar code opens the client application 302 directly to the corresponding service step. Thus, whenever the technician is performing a service for the customer, the technician can scan the bar code to immediately begin the service at the correct service step. Additionally, a location can include a plurality of bar codes (e.g., at one or more main service steps such as “interior” and “exterior”) to provide additional specificity and precision in the service.

In one or more embodiments, a service step can also allow a technician to select an option 328 to add a picture or other media content item to the service step. For example, the technician can capture an image of a location associated with the service step to store with the customer profile information. The technician can capture images of concerns or unique visual features of a location for use in performing services for the customer. To illustrate, the technician can capture images of an area (e.g., a crawl space) corresponding to the service step so that the technician can remember one or more features of the area in future services. The technician can also access an image gallery to view previously captured images associated with a service step.

If applicable, the technician can also enter details associated with a service step related to duration of the service step, charge amounts associated with a product, or quantities of a product. Specifically, different service steps may have different costs associated with performing the service steps and/or with products used in performing the service steps. To illustrate, a customer can request a specific add-on treatment that can vary in duration and cost based on the severity of a problem or the difficulty of performing the service step. Thus, the technician can enter the additional information that allows the client application to calculate the cost to the customer for performing the service step.

In one or more embodiments, the client application allows the technician to save notes with the service step. For example, if the technician notices a special concern or unique issue associated with a service step, the technician can select a note element to input instructions or comments. The client application can send the notes to the server device(s) for storing in the customer profile information. The technician can also view previously saved notes.

In one or more embodiments, the service step interface also includes a completed element 330 that allows a technician to mark that the service step is completed. For example, the completed element 330 can be a toggle element that toggles on or off to indicate whether the service step is complete or not. Additionally, toggling the completed element 330 on causes a progress indicator 332 for the service step to indicate a completion of the service step. Alternatively, the technician can mark a service step as complete by selecting one of the applicability options to indicate that the service step was not performed for a specific reason.

As illustrated in FIG. 3E, the progress indicator 332 includes a percentage amount (i.e., the completion percentage) and a circular progress bar that provides a visual indication of the amount completed to the technician. When the service step is complete, the percentage amount indicates that the service step is 100% complete, and the circular progress bar is full to match the percentage amount. Alternatively, the client application 302 can indicate completion of the service step using other methods, such as only a percentage amount or only a progress bar.

According to one or more embodiments, the client application 302 ties the progress of a parent node to the progress of any child nodes of the parent node. FIG. 3F illustrates the service step interface 320 of the hierarchy structure 310 of FIG. 3E expanded to display additional child nodes of an “Interior” service step. Additionally, a “Basement” service step that is a child node of the “Interior” service step is also a parent node that includes a plurality of child nodes (i.e., a “Crawl Space” service step and a “Remaining Areas” service step).

As illustrated in FIG. 3F, completing each child node under a parent node causes the parent node to be completed, as well. For example, if the technician marks the “Crawl Space” service step as completed, the client application 302 determines that a percentage of the “Basement” service step is completed based on the number of child steps. Thus, because the “Basement” service step has two child nodes, completing one child node causes the client application to indicate that half (50%) of the “Basement” service step is completed, and updates the progress indicator 332 accordingly. Completing both of the child nodes of the “Basement” service step causes the client application 302 to indicate that all (100%) of the “Basement” service step is completed.

According to one or more embodiments, marking a parent node as complete also marks the child nodes as complete. For example, one or more service steps may require limited inspection or treatment, such that the technician can perform the corresponding service steps quickly and/or simultaneously. After performing the plurality of service steps, instead of marking each child node as completed, the technician can mark the parent node as completed, and the client application automatically marks the child nodes as completed without requiring the technician to mark them individually.

The service step interface can also allow a technician to indicate whether a service step is recurring using a recurring element 334. In particular, the technician may perform a service step every time the technician performs a service of a particular service type for the customer. To illustrate, a technician may perform a pre-treatment inspection to identify concerns every time the technician provides a quarterly pest control service for a customer. If the technician performs the service step every time, the recurring element 334 for the service step is toggled on. If the technician performs the service step only for that particular service, the recurring element 334 is toggled off.

In one or more embodiments, the client application allows the technician to indicate whether a service step is a recurring service step based on permissions assigned to the technician. In particular, if the technician has permissions to indicate that a particular service step is recurring, the client application can send information about the recurring service step for storing in the customer profile information. For example, setting a service step as a recurring service step can modify a service type template for the customer for services of a specific service type. Alternatively, indicating that a service step is not recurring can modify an instance template on the back end, allowing the manager to view the modified instance template for the instance record.

In one or more additional embodiments, the service step interface 320 includes an add element 336 to add a new service step to the hierarchy structure 322, as illustrated in FIG. 3G. For example, selecting the add element 336 causes the client application 302 to display a step selection dialog 338 within the service step interface 320. To illustrate, the step selection dialog 338 of FIG. 3G is a pop-up window that overlays on top of the hierarchy structure 322. Alternatively, selecting the add element 336 can cause the client application 302 to display a new interface that allows the technician to add the new service step to the hierarchy structure.

The step selection dialog 338 includes a list of available types of service steps from which the technician can select for the new service step. Specifically, the list of available types of service steps can include a plurality of predefined service step types. For example, the service step types can include, but are not limited to, an area, a concern, a deficiency, a device, an inspection, a product, and a treatment. The service system uses the service step types from the origin template to populate the list of available types of service steps.

After selecting a service step type in the list of available service step types, the client application 302 can display a plurality of subtypes of service steps. In particular, selecting a service step type such as concern causes the client application 302 to display a plurality of subtypes of concerns from which the technician can choose. For example, the dialog 338 can cease to display the service step types and begin displaying service step subtypes based on the selected service type step. To illustrate, if the technician selects a new concern service step type, the dialog 338 can display a plurality of available concern subtypes from which the technician can select. For instance, for a pest control service, concern subtypes can include different pest concerns (e.g., mice, roaches, spiders). Additionally, while performing the service, the technician can create new subtypes for the current service and/or for future services if an appropriate subtype is not previously included in the dialog 338.

Selecting the service step type and a service step subtype inserts a new service step into the hierarchy structure. FIG. 3H illustrates the new service step 340 added to the hierarchy structure 322 in the service step interface 320. In one or more embodiments, the client application 302 adds the new service step 340 into the hierarchy structure 322 below a service step associated with the add element 336 that the technician selected. For example, FIG. 3H illustrates that selecting the add element 336 associated with an “Under Sinks” service step causes the client application 302 to add the new service step 340 (i.e., “Mice”) under the “Under Sinks” service step. Additionally, one or more embodiments of the client application 302 add new service steps as children below an indicated service step by default. In alternative embodiments, the client application 302 adds service steps as siblings to the indicated service step by default.

According to one or more embodiments, if the technician has permissions to modify the hierarchy structure 322, the service system synchronizes the modified hierarchy structure with server devices after the technician adds a step. Specifically, the service system synchronizes customer profile information at the technician client device with the customer profile information at the server devices. For example, the service system sends hierarchy data associated with the new service step to the server devices to store the hierarchy data in a customer profile for the customer.

In one or more embodiments, the service system also creates or modifies a template associated with the customer based on the new service step 340. For example, if the new service step 340 is applicable only to the current service, the service system can create or modify an instance template for the current service. Because the new service step 340 is only included in the instance template, the service system does not include the service step in any additional instance records. Alternatively, if the new service step 340 is applicable to all services of the service type for the customer (e.g., a recurring service step), the service system can create or modify a service type template for the customer. The service system uses the service type template for the customer to include the new service step 340 in future instance records for the customer so that future services for the customer include the new service step 340.

According to one or more embodiments, the service system also allows for the insertion of any of the service step types to any position within the hierarchy structure. Specifically, the service system may allow a technician to add a service step to any position within the hierarchy structure 322, as may serve a particular embodiment. For example, the technician can add an area (or other service step type) service step as a parent node, a child node, or a sibling node to any other node in the hierarchy structure 322. Thus, the service system provides a high degree of customization and flexibility to the technician to perform services for customers based on the customers' needs.

In one or more embodiments, the service system also allows a manager to monitor the performance of a technician in real-time. In particular, the manager can verify that the technician is performing services according to a schedule assigned to the technician. For example, the technician client device 300 can report time and location information to the managing client device via the server devices so that the manager can know where the technician is located and how quickly the technician is performing a service. To illustrate, the technician client device 300 can report location information by synchronizing location information using GPS, wireless, or other location data associated with the technician client device. The manager can use the location information to verify whether the technician is on schedule with respect to service appointments.

Additionally, the client application 302 can monitor time information associated with the performance of the service steps for a service. Specifically, the client application 302 can detect when a technician begins performing a service step and synchronize the time information with the server device(s). For example, the client application 302 can detect when the technician begins a step based on when the technician expands the service step within the hierarchy structure. Additionally, or alternatively, the client application 302 can detect that the technician begins a service step based on when the technician completes the previous service step. The client application 302 can include a hidden timer that identifies the period of time from when the technician begins the service step until the technician completes the service step.

In one or more embodiments, the client application 302 causes the technician client device to send an alert to the managing client device if the technician is performing the service too slowly or too quickly. For instance, if the technician completes a service step under a predetermined threshold period of time based on service requirements for the service, the technician client device 300 can send an alert to the managing client device indicating the deviation from the service requirements. The alert can indicate that the technician may not have performed the service step properly if the period of time was too short. Similarly, if the period of time exceeds a threshold period of time, the technician client device can alert the manager that the technician is not performing efficiently. The manager can contact the technician based on the alert (or based on a plurality of alerts) to identify the reason for the deviation(s).

Additional embodiments of the service system use time information associated with one or more technicians to determine how to route technicians to different on-site services. For example, if a first technician is taking a long time to perform a service for any reason, the service system can reroute a second technician to perform another service that was previously assigned to the first technician. To illustrate, the service system can automatically assign and reassign service assignments without input from the manager based on the time information and location information from the technicians. The service system can then alert the technicians of the change in assignment so that each technician can proceed to the next assigned services after the reassignment.

In one or more embodiments, the service system attaches cascading priorities to determine how to reassign services. Specifically, the service system assigns priority values for a plurality of different criteria that allow the service system to automatically reassign a service appointment from one technician to another. For example, the service system can assign a first priority to availability, a second priority to location, a third priority to certification to perform the service, a fourth priority to square footage and/or estimated time of a service, etc.

After a technician has finished performing the service steps in the hierarchy of service steps (e.g., by selecting a next element), the client application 302 can display additional interfaces to the technician based on the origin template. FIG. 3I illustrates a concerns interface 342 that displays concerns that the technician addressed during the service. For example, the concerns interface 342 can include a list of concerns addressed using the client application 302. To illustrate, the list of concerns can include concerns associated with service steps that have a concern service step type.

Additionally, the concerns interface 342 can display pricing associated with addressing the concerns. For example, if a concern has an additional cost that is not included in the base service, the client application 302 calculates the cost for addressing the concern based on a quantity associated with the concern (e.g., a quantity of service time units) and a corresponding cost. If costs associated with the concern are included in the base cost of the service, the client application 302 zeroes out the cost for addressing the concern, regardless of the quantity associated with the concern.

In one or more embodiments, after reviewing the concerns associated with the service, the technician selects the next element to proceed to a products interface. FIG. 3J illustrates a products interface 344 that displays the products that the technician used to perform the service steps of the service. For example, the products interface 344 can display a plurality of pest control products including devices and treatment products while performing the service for the customer. The products interface 344 can display quantities, prices, and total cost of the services, if applicable.

The technician can then select next to proceed with completing the service. In one or more embodiments, the client application 302 can display additional interfaces for reviewing service instructions, ensuring that property gates are secure, ending weather information for the service, service line items, and documents. To illustrate, the technician can scan a document or form (e.g., a form required by law for a specific service) to attach the document to the instance record. The client application 302 can also automatically convert the document to a fillable form that allows the technician to enter information into a digital record to be stored with the instance record. Additionally, the client application 302 can automatically prepopulate information in a document with customer profile information and/or service information by analyzing the form and inputting the corresponding information from the customer profile and/or other sections of the instance record.

In one or more embodiments, the client application 302 displays an invoice interface 346 that displays a service report that summarizes the service for the customer, as illustrated in FIG. 3K. Additionally, the invoice interface 346 can display areas treated, product usage, concerns addressed, deficiencies, service steps and/or a summary of the hierarchy structure for the service, final cost, and/or other information associated with the service. In at least some embodiments, the invoice interface 346 allows the customer to sign the service report electronically to reduce the usage of paper. The service system can then send a copy of the service report to the customer via email or other electronic communication.

After the customer reviews and signs the service report in the invoice interface 346, the client application 302 displays a payment interface 348, as illustrated in FIG. 3L. The payment interface 348 allows the technician to indicate a payment method associated with the service. For example, the payment interface 348 displays a plurality of selectable payment elements 350 associated with a plurality of different payment methods (e.g., credit card, EFT, check, cash, deferred payment). Selecting a payment element 350 selects the corresponding payment method for the outstanding payment amount. Alternatively, the technician can select a payment element 350 (e.g., “Multiple) that allows the customer to pay using a plurality of different payment methods. As illustrated in FIG. 3L, a customer opts to pay $50 by check and defer the remainder for later payment, such as in multiple payment installments.

Additionally, the payment interface 348 can indicate whether the customer has any outstanding balances. For example, FIG. 3L illustrates that the payment interface 348 shows whether the customer has unpaid balances associated with one or more other service types. To illustrate, a balance indicator 352 can indicate a number and dollar amount of unpaid service types that the customer has outstanding. In one or more embodiments, the client application 302 allows the technician to charge the customer for a plurality of services (e.g., a current service and one or more unpaid services) at the same time.

After the technician selects the payment method(s), and the customer pays for the service using the selected payment method(s), the technician can select a complete service element to complete the service. When the technician selects the complete service element, the client application 302 closes the service and finalizes the instance record for the customer. Additionally, the client application 302 causes the technician client device 300 to send the instance record, including the service report, to the server devices. The server devices then store the instance record and service report in the customer profile information for the customer for viewing by the technician, the manager, and/or other users. For customers choosing to pay by credit card, debit card, or EFT, the information is passed through the server to a third party merchant service provider for processing. The results of the payment are also sent back to the technician client device 300 to confirm payment was successful.

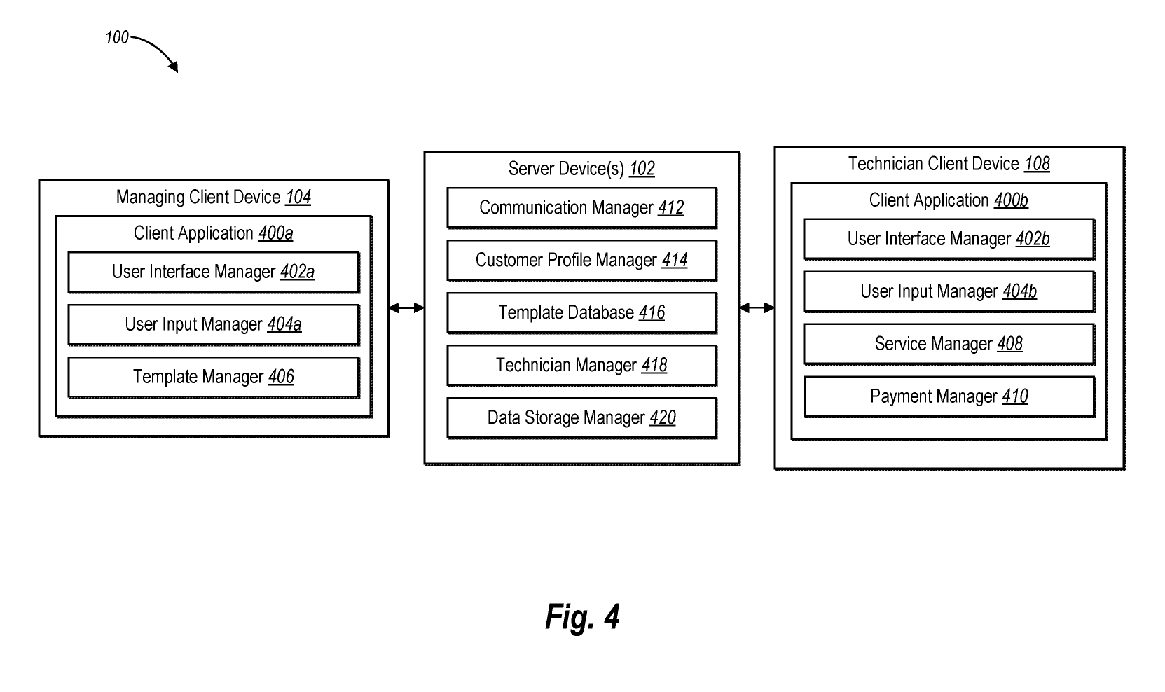

As previously mentioned, customizing instance records for providing services to customers can be useful to service providers. Additionally, maintaining consistency and performance across a plurality of different services is also important. As described above, a service system can provide both of these benefits by using template-based instance records and real-time synchronization of information during performance of services. FIG. 4 illustrates a schematic diagram of the service system 100 of FIG. 1 including a managing client device 104, server device(s) 102, and a technician client device 108 for providing customized services to customers. Although the service system 100 is depicted as having various components, the service system may have any number of additional or alternative components. Additionally, although FIG. 4 illustrates the service system 100 including the components on a managing client device 104, server device(s) 102, and a technician client device 108, the service system 100 can include more or fewer devices. For example, the server device(s) 102 can include or be combined with the managing client device 104.

In one or more embodiments, each of the components and subcomponents of the service system 100 can be in communication with one another using any suitable communication technologies. It will be recognized that although the subcomponents of the service system 100 are shown to be separate in FIG. 4, any of the subcomponents may be combined into fewer components, such as into a single component, or divided into more components as may serve a particular implementation. Furthermore, although the components of FIG. 4 are described in connection with the service system 100, at least some of the components for performing operations in conjunction with the service system 100 described herein may be implemented on other devices and/or with other systems.

The components of the service system 100 can include software, hardware, or both. For example, the components of the service system 100 (e.g., the managing client device 104, server device(s) 102, and the technician client device 108) can include one or more instructions stored on computer-readable storage mediums and executable by processors of one or more computing devices. When executed by the one or more processors, the computer-executable instructions of the service system 100 can cause the computing device(s) to perform the service customization and management processes described herein. Alternatively, the components of the service system 100 can comprise hardware, such as a special purpose processing device to perform a certain function or group of functions. Additionally, the components of the service system 100 can comprise a combination of computer-executable instructions and hardware.

Furthermore, the components of the service system 100 performing the functions described herein with respect to the service system 100 may, for example, be implemented as part of a stand-alone application, as a module of an application, as part of a suite of applications, as a plug-in for applications including content creation applications, as a library function or functions that may be called by other applications, and/or as a cloud-computing model. Thus, various components of the service system 100 may be implemented as part of a stand-alone application on a personal computing device or a mobile device. Alternatively or additionally, the components of the service system 100 may be implemented in any application that allows delivery of content to users, including, but not limited to, applications in PESTMATE™ and PESTPAD™.

As previously described, the service system 100 includes a managing client device 104. The managing client device 104 includes a client application 400a with various components (e.g., a user interface manager 402a, a user input manager 404a, and a template manager 406). The client application 400a can be a management application that allows a manager to manage clients, services, and employees (e.g., technicians). The technician client device 108 also includes a client application 400b with various components (e.g., a user interface manager 402b, a user input manager 404b, a service manager 408, and a payment manager 410). The client application 400b can be a service application that allows a technician to perform a service for a customer.

As mentioned, the client applications 402a, 402b on the managing client device 104 and on the technician client device 108 include a user interface manager 402a, 402b. The user interface manager 402a at the managing client device 104 facilitates the display of information on the managing client device 104. Specifically, the user interface manager 402a provides, manages, and/or controls a user interface that allows the manager to view information associated with a service, customer, or a technician. For example, the user interface manager 402a on the managing client device 104 can provide a variety of user interfaces that facilitates the creation of templates associated with one or more service types, management of technician assignments, monitoring of technician performance, and customer requests.

Additionally, the user interface manager 402b on the technician client device 108 facilitates the display of information on the technician client device 108. In particular, the user interface manager 402b provides, manages, and/or controls a user interface that allows the technician to view information associated with a service or customer. For example, the user interface manager 402b on the technician client device 108 can provide a variety of user interfaces that facilitate the performance of a service by displaying service steps associated with the service. Additionally, the user interface manager 402b can display information about the technician's schedule and service assignments.

The client applications 402a, 402b also include a user input manager 404a, 404b. In one or more embodiments, the user input manager 404a, 404b detects, receives, and/or facilitates user input in any suitable manner. In some examples, the user input detector can detect one or more user interactions with respect to the user interface. As referred to herein, a “user interaction” means a single interaction, or combination of interactions, received from a user by way of one or more input devices. The client applications 402a, 402b perform one or more functions in response to detected user interactions.

For example, user input manager 404a, 404b can detect a user interaction from a keyboard, mouse, touch pad, touchscreen, and/or any other input device. In the event the client devices include a touchscreen, the user input detector can detect one or more touch gestures (e.g., swipe gestures, tap gestures, pinch gestures, or reverse pinch gestures) from a user that forms a user interaction. In some examples, a user can provide the touch gestures in relation to and/or directed at one or more graphical objects or graphical elements of a user interface.

The client application 400a on the managing client device 104 also includes a template manager 406. The template manager 406 facilitates the creation, editing, and management of templates for use in providing services to customers. Specifically, the template manager 406 allows a manager to create and edit service templates that the service system 100 uses to create instance records. For example, the template manager 406 can allow a manager to create and edit origin templates, service type templates, and instance templates for providing consistency across services while also allowing for customization base on customers' needs.

In one or more embodiments, the client application 400b on the technician client device 108 includes a service manager 408. The service manager 408 facilitates the performance of a service for a customer. In particular, the service manager 408 allows a technician to view service steps and other service information in an instance record for the customer so that the technician can perform the service according to the service steps. Additionally, the service manager 408 allows the technician to interact with and/or modify the service steps based on permissions assigned to the technician.

The client application 400b on the technician client device 108 also includes a payment manager 410. Specifically, the payment manager 410 facilitates customer payment for services rendered. For example, the payment manager 410 can communicate with one or more payment networks to allow the customer to enter into electronic payment transactions with the service provider. To illustrate the payment manager 410 can allow technicians to charge customers via credit card, ACH, or other electronic payment methods.

According to one or more embodiments, the server device(s) 102 include a communication manager 412, a customer profile manager 414, a template database 416, a technician manager 418, and a data storage manager 420. Although the server device(s) 102 of FIG. 4 include certain components, the server device(s) 102 can include additional components associated with providing services to customer. For example, the server device(s) 102 facilitate communications and storage of data associated with providing services.

As mentioned, the server device(s) 102 can include a communication manager 412 that facilitates communications with the managing client device 104 and the technician client device 108. For example, the communication manager 412 can send data to and receive data from the managing client device 104. Additionally, the communication manager 412 can send data to and receive data from the technician client device 108. In at least some implementations, the communication manager 412 can route data between the managing client device 104 and the technician client device 108 in connection with performing a service for a customer.

The server device(s) 102 also include a customer profile manager 414 that facilitates the storage and management of customer profiles. For example, the customer profile manager 414 obtains customer profile information from the managing client device 104 and/or the technician client device 108 via the communication manager 412. The customer profile manager 414 associates the customer profile information with a corresponding customer profile and stores the customer profile information in the customer profile at the data storage manager 420. Additionally, the customer profile manager 414 can retrieve customer profile information from a customer profile for sending to the managing client device 104 or the technician client device 108.

In one or more embodiments, the template database 416 facilitates the management of templates for creating instance records. Specifically, the template database 416 can communicate with the data storage manager 420 to store one or more templates for a service type and/or customers. For example, the template database 416 can manage origin templates for various service types. Additionally, the template database 416 can manager service type templates and instance templates for customers. The template database 416 uses the templates to create instance records for providing services to customers.

The technician manager 418 facilitates the management of technicians providing services to customers. In particular, the technician manager 418 can manage schedules and assignments associated with technicians. For example, the technician manager 418 can obtain schedule information, service performance information, location information, and/or other information about the technicians via the communication manager 412. The technician manager 418 can communicate with the data storage manager 420 to store technician information (e.g., schedules, assignments, service performance, location, communications, alerts) in technician profiles. Furthermore, the technician manager 418 can modify schedules or assignments of technicians based on the technician information.

The server device(s) 102 also includes a data storage manager 420 to manage data that the other components in the service system 100 use and/or produce. Specifically, the data storage manager 420 can communicate with the other components in the server device(s) 102 (i.e., the communication manager 412, the customer profile manager 414, the template database 416, and the technician manager 418) to obtain data that the components have produced for storage and/or use by one or more of the components. To illustrate, the data storage manager 420 can store data that includes, but is not limited to, customer profiles, technician profiles, templates, and instance records.

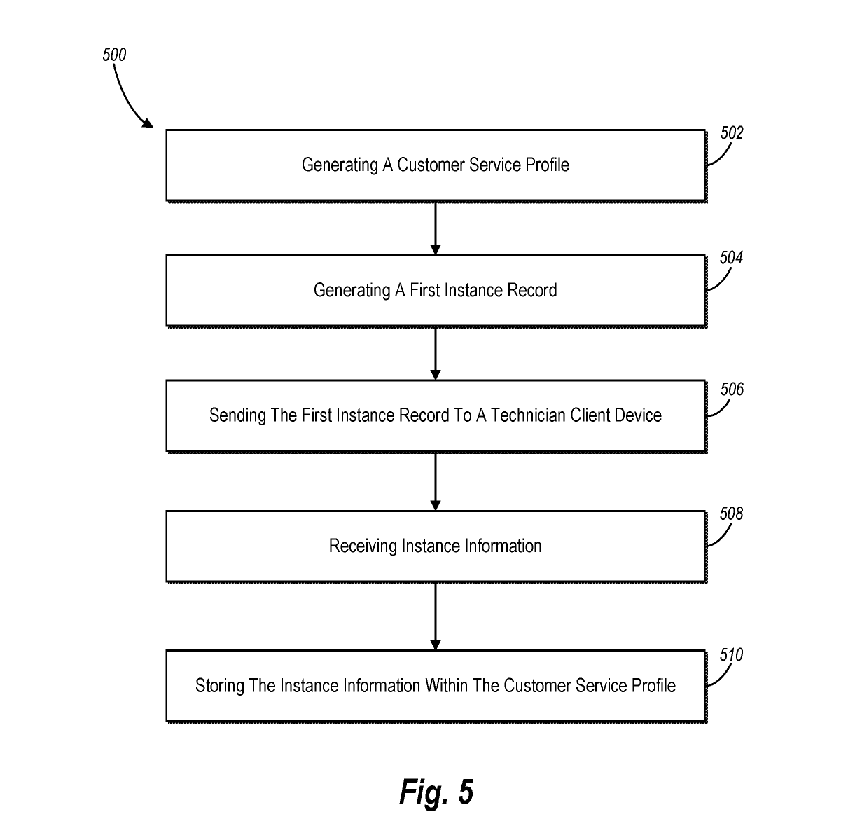

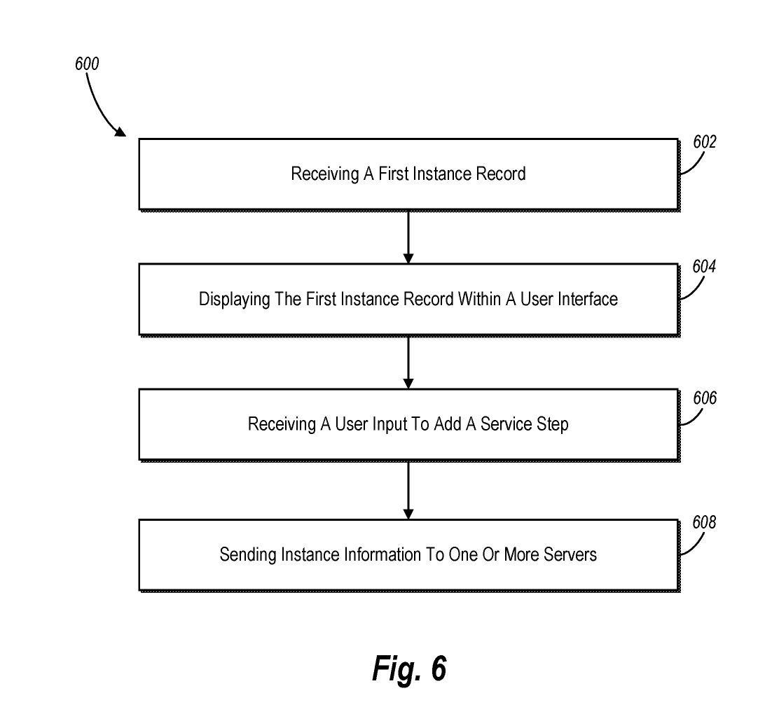

FIGS. 1-4, the corresponding text, and the examples, provide a number of different systems and devices for providing customized services to customers. In addition to the foregoing, embodiments can be described in terms of flowcharts comprising acts and steps in a method for accomplishing a particular result. For example, FIGS. 5 and 6 illustrate flowcharts of exemplary methods in accordance with one or more embodiments.

FIG. 5 illustrates a flowchart of a series of acts in a method 500 of generating an instance record associated with a service for a customer. The method 500 includes an act 502 of generating a customer service profile. For example, act 502 involves generating, by one or more servers, a customer service profile for a first customer, the customer service profile comprising information associated with the first customer including a service type. To illustrate, act 502 can involve receiving, from the client device, a selection to begin the first service for the first customer, and identifying the service type of the first service from the customer service profile for the first customer.

As part of act 502, or as an additional act, the method 500 can include receiving, from a client device associated with a sales technician, visit information for a visit to a location of the first customer prior to the first customer signing a service agreement, storing, by the one or more servers, the visit information with location data for the location, receiving, from the client device associated with the sales technician in connection with the visit information for the location, a request to generate the customer service profile for the first customer, and generating the customer service profile for the first customer in response to the received request, the customer service profile comprising a service agreement for the first customer. For example, the visit information can include a knock event or a come back event.

The method 500 includes an act 504 of generating a first instance record. For example, act 504 involves generating, by the one or more servers and based on the service type in the customer service profile, a first instance record associated with a first service for the first customer. Act 504 can involve generating the first instance record comprising a hierarchy of service steps associated with the first service. Additionally, act 504 can involve customizing the hierarchy of service steps associated with the first service for the first customer based on a geographic location of the first customer.

As part of act 504, or as an additional act, the method 500 can include generating an origin template associated with the service type, the origin template comprising a plurality of service steps for the service type, wherein the first instance record includes the template information from the origin template. The method 500 can also include generating a service type template associated with the service type for the first customer, the service type template comprising the plurality of service steps from the origin template and at least one additional service step customized for the first customer, and generating the first instance record to include the at least one additional service step customized for the first customer.

The method 500 also includes an act 506 of sending the first instance record to a technician client device. For example, act 506 involves sending the first instance record to a client device associated with a service technician. Act 506 can involve sending the first instance record for display in a client application at the client device associated with the service technician.

The method 500 further includes an act 508 of receiving instance information. For example, act 508 involves receiving, from the client device, instance information in connection with the first service. The instance information can include completion information for the service steps associated with the first service.

Additionally, the method 500 includes an act 510 of storing the instance information within the customer service profile. For example, act 510 can involve storing the completion information within the customer service profile. Act 510 can also involve storing at least one new service step in a service type template for the customer within the customer service profile.

The method 500 can further include generating, based on the customer service profile including the instance information in connection with the first service, a second instance record associated with a second service of the service type for the first customer, and sending the second instance record to the client device associated with the service technician.

The method 500 can also include generating, based on a customer service profile for a second customer, a second instance record associated with a second service for the second customer, wherein the second instance record associated with the second customer comprises a different hierarchy of service steps than the first instance record associated with the first customer.

The method 500 can also include receiving, from the client device associated with the service technician, an alert indicating that a time associated with the first service exceeds a predetermined threshold, determining, based on the alert, that the service technician will be unable to perform a second service for a second customer within a scheduled time window, and reassigning the second service to a second service technician.

FIG. 6 illustrates a flowchart of a series of acts in a method 600 of modifying an instance record. The method 600 includes an act 602 of receiving a first instance record. For example, act 602 involves receiving, from one or more servers at a client device associated with a service technician, a first instance record associated with a first service for a customer, the first instance record comprising a hierarchy of service steps. Act 602 can involve receiving the first instance record in response to sending a notification to begin the first service for the customer.

The method 600 also includes an act 604 of displaying the first instance record within a user interface. For example, act 604 can involve displaying the hierarchy of service steps including a plurality of parent steps, child steps, and sibling steps in an expandable and collapsible hierarchy structure.

Additionally, the method 600 includes an act 606 of receiving a user input to add a service step. For example, act 606 involves receiving, by the client device, a user input to add a new service step to the hierarchy of service steps in the first instance record in connection with the first service.

Act 606 can involve receiving an indication of a location in the hierarchy of service steps, adding the new service step to the location in the hierarchy of service steps, and defining a hierarchical relationship between the new service step and at least one additional step in the hierarchy of service steps based on the location, wherein the hierarchical relationship comprises a parent relationship, a child relationship, or a sibling relationship. Additionally, act 606 can involve receiving, from the one or more servers, a second instance record associated with a second service for the customer, the second instance record comprising the hierarchy of service steps with the new service step.

The method 600 also includes an act 608 of sending instance information to one or more servers. For example, act 608 involves sending, to the one or more servers and based on the received user input, instance information associated with the first service. Act 608 can involve sending completion information associated with the hierarchy of service steps to the one or more servers.

The method 600 can further include scanning a document using an image capture device of the client device, converting the document to a fillable digital form, retrieving, from the one or more servers, customer profile information associated with the customer from a customer service profile, and prepopulating the customer profile information into one or more fields of the fillable digital form.

The method 600 can also include detecting that a service step from the hierarchy of service steps is active, monitoring a service time associated with the service step from the hierarchy of service steps, and synchronizing, to the one or more servers, the service time associated with the service step while the service step is active.

The method 600 can also include receiving a plurality of service requirements associated with the hierarchy of service steps, detecting, in connection with the first service, a deviation from a service requirement from the plurality of service requirements, and sending, to the one or more servers, an alert associated with the detected deviation.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 7 illustrates a block diagram of exemplary computing device 700 that may be configured to perform one or more of the processes described above. One will appreciate that one or more computing devices such as the computing device 700 may implement the object digitizing system 700. As shown by FIG. 7, the computing device 700 can comprise a processor 702, a memory 704, a storage device 706, an I/O interface 708, and a communication interface 710, which may be communicatively coupled by way of a communication infrastructure 712. In certain embodiments, the computing device 700 can include fewer or more components than those shown in FIG. 7. Components of the computing device 700 shown in FIG. 7 will now be described in additional detail.

In one or more embodiments, the processor 702 includes hardware for executing instructions, such as those making up a computer program. As an example and not by way of limitation, to execute instructions for digitizing real-world objects, the processor 702 may retrieve (or fetch) the instructions from an internal register, an internal cache, the memory 704, or the storage device 706 and decode and execute them. The memory 704 may be a volatile or non-volatile memory used for storing data, metadata, and programs for execution by the processor(s). The storage device 706 includes storage, such as a hard disk, flash disk drive, or other digital storage device, for storing data or instructions related to object digitizing processes (e.g., digital scans, digital models).

The I/O interface 708 allows a user to provide input to, receive output from, and otherwise transfer data to and receive data from computing device 700. The I/O interface 708 may include a mouse, a keypad or a keyboard, a touch screen, a camera, an optical scanner, network interface, modem, other known I/O devices or a combination of such I/O interfaces. The I/O interface 708 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 708 is configured to provide graphical data to a display for presentation to a user. The graphical data may be representative of one or more graphical user interfaces and/or any other graphical content as may serve a particular implementation.

The communication interface 710 can include hardware, software, or both. In any event, the communication interface 710 can provide one or more interfaces for communication (such as, for example, packet-based communication) between the computing device 700 and one or more other computing devices or networks. As an example and not by way of limitation, the communication interface 710 may include a network interface controller (NIC) or network adapter for communicating with an Ethernet or other wire-based network or a wireless NIC (WNIC) or wireless adapter for communicating with a wireless network, such as a WI-FI.

Additionally, the communication interface 710 may facilitate communications with various types of wired or wireless networks. The communication interface 710 may also facilitate communications using various communication protocols. The communication infrastructure 712 may also include hardware, software, or both that couples components of the computing device 700 to each other. For example, the communication interface 710 may use one or more networks and/or protocols to enable a plurality of computing devices connected by a particular infrastructure to communicate with each other to perform one or more aspects of the digitizing processes described herein. To illustrate, the digitizing process can allow a plurality of devices (e.g., an image capture device and one or more processing computing devices) to exchange information using various communication networks and protocols for digitizing a real-world object.

In the foregoing specification, the present disclosure has been described with reference to specific exemplary embodiments thereof. Various embodiments and aspects of the present disclosure(s) are described with reference to details discussed herein, and the accompanying drawings illustrate the various embodiments. The description above and drawings are illustrative of the disclosure and are not to be construed as limiting the disclosure. Numerous specific details are described to provide a thorough understanding of various embodiments of the present disclosure.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

What is claimed is:

1. A method, comprising:
generating, by one or more servers, a customer service profile for a first customer, the customer service profile comprising information associated with the first customer including a service type;
generating, by the one or more servers and based on the service type in the customer service profile, a first instance record associated with a first service of the service type for the first customer;
sending the first instance record to a client device associated with a service technician;
receiving, from the client device, instance information in connection with the first service; and
storing the instance information within the customer service profile.

2. The method as recited in claim 1, further comprising generating an origin template associated with the service type, the origin template comprising a plurality of service steps for the service type, wherein the first instance record includes template information from the origin template.

3. The method as recited in claim 2, further comprising:
generating a service type template associated with the service type for the first customer, the service type template comprising the plurality of service steps from the origin template and at least one additional service step customized for the first customer; and
generating the first instance record to include the at least one additional service step customized for the first customer.

4. The method as recited in claim 3, further comprising:
receiving, from the client device, a selection to begin the first service for the first customer; and
identifying the service type of the first service from the customer service profile for the first customer.

5. The method as recited in claim 1, further comprising:
generating, based on the customer service profile including the instance information in connection with the first service, a second instance record associated with a second service of the service type for the first customer; and
sending the second instance record to the client device associated with the service technician.

6. The method as recited in claim 1, wherein generating the first instance record comprises generating the first instance record comprising a hierarchy of service steps associated with the first service.

7. The method as recited in claim 6, further comprising generating, based on a customer service profile for a second customer, a second instance record associated with a second service for the second customer, wherein the second instance record associated with the second customer comprises a different hierarchy of service steps than the first instance record associated with the first customer.

8. The method as recited in claim 6, further comprising customizing the hierarchy of service steps associated with the first service for the first customer based on a geographic location of the first customer.

9. The method as recited in claim 1, further comprising:
receiving, from the client device associated with the service technician, an alert indicating that a time associated with the first service exceeds a predetermined threshold;
determining, based on the alert, that the service technician will be unable to perform a second service for a second customer within a scheduled time window; and
reassigning the second service to a second service technician.

10. The method as recited in claim 1, further comprising:
receiving, from a client device associated with a sales technician, visit information for a visit to a location of the first customer prior to the first customer signing a service agreement;
storing, by the one or more servers, the visit information with location data for the location;
receiving, from the client device associated with the sales technician in connection with the visit information for the location, a request to generate the customer service profile for the first customer; and
generating the customer service profile for the first customer in response to the received request, the customer service profile comprising a service agreement for the first customer.

11. A method, comprising:
receiving, from one or more servers at a client device associated with a service technician, a first instance record associated with a first service of a service type for a customer, the first instance record comprising a hierarchy of service steps;
displaying, by the client device, the first instance record within a user interface;
receiving, by the client device, a user input to add a new service step to the hierarchy of service steps in the first instance record in connection with the first service; and
sending, to the one or more servers and based on the received user input, instance information associated with the first service.

12. The method as recited in claim 11, wherein displaying the first instance record within the user interface comprises displaying the hierarchy of service steps comprising a plurality of parent steps, child steps, and sibling steps in an expandable and collapsible hierarchy structure.

13. The method as recited in claim 11, wherein receiving the user input to add the new service step to the hierarchy of service steps further comprises:
receiving an indication of a location in the hierarchy of service steps;
adding the new service step to the location in the hierarchy of service steps; and
defining a hierarchical relationship between the new service step and at least one additional step in the hierarchy of service steps based on the location, wherein the hierarchical relationship comprises a parent relationship, a child relationship, or a sibling relationship.

14. The method as recited in claim 13, further comprising receiving, from the one or more servers, a second instance record associated with a second service for the customer, the second instance record comprising the hierarchy of service steps with the new service step.

15. The method as recited in claim 11, further comprising:
detecting that a service step from the hierarchy of service steps is active;
monitoring a service time associated with the service step from the hierarchy of service steps; and
synchronizing, to the one or more servers, the service time associated with the service step while the service step is active.

16. The method as recited in claim 11, further comprising:
receiving a plurality of service requirements associated with the hierarchy of service steps;
detecting, in connection with the first service, a deviation from a service requirement from the plurality of service requirements; and
sending, to the one or more servers, an alert associated with the detected deviation.

17. The method as recited in claim 11, further comprising:
scanning a document using an image capture device of the client device;
converting the document to a fillable digital form;
retrieving, from the one or more servers, customer profile information associated with the customer from a customer service profile; and
prepopulating the customer profile information into one or more fields of the fillable digital form.

18. A system, comprising:
at least one processor;
a non-transitory computer readable storage medium comprising instructions that, when executed by the at least one processor, cause the system to:
generate a customer service profile for a first customer, the customer service profile comprising information associated with the first customer including a service type;
generate, based on the service type in the customer service profile, a first instance record associated with a first service of the service type for the first customer;
send the first instance record to a client device associated with a service technician;
receive, from the client device, instance information in connection with the first service; and
store the instance information within the customer service profile.

19. The system as recited in claim 18, further comprising instructions that, when executed by the at least one processor, cause the system to:
generate an origin template associated with the service type, the origin template comprising a plurality of service steps for the service type, wherein the first instance record includes template information from the origin template.
generate a service type template associated with the service type for the first customer, the service type template comprising the plurality of service steps from the origin template and at least one additional service step customized for the first customer; and
generate the first instance record to include the at least one additional service step customized for the first customer.

20. The system as recited in claim 18, further comprising instructions that, when executed by the at least one processor, cause the system to generate, based on a customer service profile for a second customer, a second instance record associated with a second service for the second customer, wherein the second instance record associated with the second customer comprises a different hierarchy of service steps than the first instance record associated with the first customer.
